(19) United States
(12) Patent Application Publication
(10) Pub. No.: US 2003/0008038 A1
(43) Pub. Date: Jan. 9, 2003

(54) Frozen crustless sliced sandwich and method and apparatus for making same

(75) Inventors: Robert John Valenzky JR., Akron, OH (US); Duane Nathan Eberhart, Wooster, OH (US)

Correspondence Address: ROBERT V. VICKERS, VICKERS, DANIELS & YOUNG, Suite 2000, 50 Public Square, Cleveland, OH, 44113-2235, US

(73) Assignee: The J.M. Smucker Company, an Ohio corporation

(21) Appl. No.: 10/180,709

(22) Filed: Jun. 25, 2002

Related U.S. Application Data
(63) Continuation-in-part of application No. 09/898,385, filed on Jul. 5, 2001.
(60) Provisional application No. 60/342,338, filed on Dec. 19, 2001.

(51) Int. Cl. A23G 3/00

(52) U.S. Cl. 426/94

(57) ABSTRACT

A frozen sandwich for commercial sales comprising a first portion of bread cut from a first slice of crusted bread and having an outer surface, a given periphery and a center area surrounded by a marginal area. A layer of masticated, plasticized cheese deposited on the center area of the first slice and spaced inwardly from the marginal area. A second portion of bread cut from a second slice of crusted bread and overlying the first portion and the center layer of cheese. The second portion also having an outer surface, a periphery generally matching the periphery of the first portion and a marginal area generally matching and coextensive with the marginal area of the first portion where the marginal areas are compressed together to form a seal generally matching the peripheries of the bread portions and the outer surfaces of the bread portions are heat scorched to transform a thin skin of the cut bread portions into a toasted bread condition.

This application is a continuation-in-part of prior copending application Ser. No. 898,385 filed Jul. 5, 2001. Further, this application claims priority rights under provisional application Ser. No. 342,338 filed Dec. 19, 2001.

The present invention relates to the art of prepared sandwiches for commercial sales in institutional and retail establishments and more particularly to a novel frozen pre-grilled cheese sandwich and method and apparatus for making such novel frozen sandwich. The invention involves features used for making frozen peanut butter and jelly sandwiches for commercial distribution.

### INCORPORATION BY REFERENCE

This application is related to copending application Ser. No. 898,385 filed Jul. 5, 2001. This application together with the references relied upon therein and cited there against are hereby incorporated by reference. This prior application discloses a method and apparatus for making a frozen crustless cheese sandwich that is pre-grilled, packaged hermetically, frozen and then distributed commercially. The disclosure of this prior application need not be repeated herein, even though the prior application is not prior art. Also incorporated herein is Kretchman U.S. Pat. No. 6,004,596 disclosing the existing technology for making crustless peanut butter and jelly sandwiches. A failed attempt to produce a crustless sandwich is disclosed in Solerud U.S. Pat. No. 3,782,270, which patent is also incorporated by reference herein as background information on crustless sandwiches.

Another prior effort to make crustless sandwiches, this time a cheese sandwich using a slice of cheese, is disclosed in Perrine U.S. Pat. No. 6,231,898. This prior art patent is incorporated by reference as background information on making crustless cheese sandwich from a slice of cheese. This sandwich is to be cooked by the consumer to melt the cheese. In the production of a crustless sandwich in accordance with the present invention, a food pump is used to masticate and plasticize bulk cheese for depositing onto a slice of bread preparatory to making a crustless cheese sandwich. The apparatus used for this purpose and disclosed in the present application is described in Powers U.S. Pat. No. 5,464,338. This patent is also incorporated by reference herein so that the details of the equipment to masticate, de-aerate and pump the bulk cheese to the depositing device need not be further explained. This prior art patent is background and is used in the preferred embodiment of the present invention.

### BACKGROUND OF INVENTION

A crustless peanut butter sandwich manufactured by the method disclosed in Kretchman U.S. Pat. No. 6,004,596 has been commercially distributed and marketed in the United States and has enjoyed immediate commercial success. Based upon this experience, unsuccessful efforts have been made to adapt this technology to a crustless sandwich filled with cheese. One of these failed efforts is disclosed in Perrine U.S. Pat. No. 6,231,898. Commercial success has not been forthcoming due to the technical difficulties in converting from peanut butter and jelly to cheese as the center filling. Prior attempts to make a cheese version of the Kretchman crustless sandwich have involved merely placing a slice of processed cheese between two slices of bread. The bread slices are ultimately cut into the desired shape and then sealed by pressure applied between the slices in an area around the cheese. Such sandwich used the technology in the prior patent by merely substituting a slice of cheese in the center of the crustless sandwich for the peanut butter and jelly filling. This cheese sandwich construction produced a sandwich that was of ten frozen. The consumer had to thaw and toast the sandwich in a convection oven. The result was a toasted cheese sandwich quite different from the desired grilled cheese sandwich. In some instances the frozen cheese sandwich was merely thawed and eaten as done with the peanut butter and jelly counterpart. This sandwich was generally unacceptable. When using a cheese slice, the sandwich had properties dictated by the sliced cheese used in the sandwich. The heating process in a toaster or convection oven tended to melt the cheese. This changed the structure of the resulting toasted sandwich. This prior sandwich did not duplicate a domestic grilled cheese sandwich, which is the basic commercial and technical objective of the present invention. To melt the solid cheese in the sandwich, the bread was throughly heated. This deep heating changed the bread to create a toasted sandwich. These technical problems contributed, to the marketing problems of converting the quite successful peanut butter and jelly sandwich to an acceptable cheese sandwich. Consumers would prefer a “home” grilled cheese sandwich over the sandwich of the prior art which was toasted to be eaten. Such “toasted” sandwich did not duplicate a grilled cheese sandwich. Consequently, there is a need for a method to make a frozen crustless sandwich that duplicates a grilled cheese sandwich and also has the crustless sandwich characteristics of a Kretchman sandwich.

The invention relates to making a cheese sandwich simulating a grilled cheese sandwich; however, some features developed for the cheese sandwich have implications for making novel peanut butter and jelly sandwiches. Such sandwiches have been sold for years and are constantly in need of both technical and commercial updates as well as production cost reductions.

### THE PRESENT INVENTION

The present invention relates to a frozen cheese sandwich utilizing the technology of the commercially successful peanut butter and jelly sandwich without the deficiencies caused by the mere conversion of a peanut butter and jelly sandwich to a cheese sandwich by using a slice of cheese as a substitute for the inner filling. This sandwich of the present invention employs new technology directed specifically toward the production of a frozen crustless sandwich having a cheese filling which is toasted to simulate grilling and can be reconstructed merely by a short microwave cycle into a sandwich duplicating a homemade grilled cheese sandwich. By using the present invention, there is no need for through toasting the sandwich to adversely affect the resulting sandwich and, thereby, change the internal cheese of the sandwich. In accordance with the present invention, there is provided a method and apparatus for making a crustless cheese sandwich comprising slices of bread having a moisture content in the general range of 40%-60%. The first slice of bread is placed on a platen having a center depression clearance recess. The platen is moved until the bread is at a deposition station. At the deposition station or area, an unmelted masticated, plasticized cheese is deposited as a layer onto the center of the first slice of bread leaving an outer section of the bread slice free of cheese. In accordance with the invention, the cheese is masticated and plasticized in a pump as disclosed in Powers U.S. Pat. No. 5,464,338. This pump forces the cheese through a nozzle which either moves over the lower bread slice in a linear direction or is rotated over the first slice of bread. In both situations, the cheese is progressively deposited onto the center portion of the lower bread slice. In accordance with another embodiment of the invention, the pump forces the plasticized cheese through a large opening generally matching the deposit shape of the cheese. As the pump forces the plasticized cheese outwardly, a section is cut off and allowed to drop as a thin layer onto the first slice of bread in the center portion of the bread slice. The deposited cheese is applied preparatory to making a frozen crustless cheese sandwich. By forcing the cheese progressively onto the first slice of bread or depositing the plasticized cheese as a section cut from the cheese oozing from a large nozzle, there is no need for a melting operation that could cause heat distortion of the bread or absorption of the cheese into the bread. Furthermore, the masticated, plasticized cheese deposited in the center of the first bread slice has the consistency, taste and characteristic of a cheese in a grilled cheese sandwich. This characteristic cannot be duplicated by a highly viscous cheese spread, nor by a solid slice of processed cheese. The characteristics of the cheese layer mimics the inner layer of cheese in a conventional grilled cheese sandwich. In accordance with an aspect of the invention, the cheese is plasticized. With the pump now used, the masticated cheese is de-aerated to remove entrapped air. The cheese is either deposited progressively as a layer at a low temperature by merely forcing the unmelted cheese onto the bread or it is dropped onto the bread as a cut off section of plasticized cheese forced through a large nozzle opening located above the bread. Thus, the bread is not disturbed, but the deposited layer of cheese is not merely a slice of processed cheese or liquid sauce that would penetrate the bread, especially after prolonged exposure.

In accordance with an aspect of the invention, the cheese is pumped or forced through a nozzle which is moved linearly to deposit a flat layer of cheese. Linear movement of a nozzle over the bread to deposit pumped cheese onto the bread is the preferred implementation. The cheese is a continuous layer or is individual stripes according to the openings in the nozzle through which the plasticized cheese is pumped. In accordance with another embodiment of the invention, the cheese depositing nozzle is rotated above the lower bread slice to progressively create a circle of unmelted cheese on the center of the bread slice. The unmelted cheese is a plasticized cheese layer and is not a viscous sauce or a solid slice of processed cheese. Consequently, a selected quality cheese is forced progressively or dropped as a section onto the first slice of bread. Thereafter, a second slice of bread is placed over the first slice to form a crusted sandwich with a center filling of cheese. Thereafter, the bread slices are cut into a given shape surrounding the center area of the bread slices so a cut bread portion is on both sides of the cheese layer. Consequently, two bread portions with marginal areas surrounding the cheese layer are created by the cutting operation. This cutting action removes the crust from the two bread slices, and is by a knife or cutting edge acting against a cutting surface. This prevents stretching of the bread with the resulting transformation of texture. Stretched bread when frozen becomes brittle and loses its natural organoleptic textures. The bread slices are then pressed together at their overlying marginal areas to seal the cheese between the cut bread portions to thereby form a crustless sandwich. The oppositely facing bread surfaces are rapidly heated to toast only a thin layer or skin of the bread portions. In this manner, the crustless sandwich simulates a grilled condition, and is ready to eat. Such surface toasting process would not be effective if the cheese were a solid slice of cheese in the middle. The cheese would remain solid and the resulting sandwich would taste like a cheese slice between two uncooked slices of bread. By the invention, the cheese is not heated. Thus, the rapidly toasted bread surfaces create a cheese sandwich simulating a sandwich normally made domestically. The sandwich does not require through toasting by the ultimate user.

The present invention uses deposited plasticized cheese which is an edible condition, which is not to be heated to any degree to be modified during the fast toasting of the outer surfaces to simulate grilling. Thereafter, the cheese sandwich, which is ready to eat, is frozen and hermetically sealed for commercial distribution. The ultimate consumer merely thaws the crustless sandwich and places it in a microwave oven for a short time at a medium power level. This raises the temperature of the sandwich and heats the internal cheese filling so that the sandwich duplicates a homemade grilled cheese sandwich. There is no need to through toast the sandwich after it is thawed with the resulting disturbance of the cheese filling and change of the bread consistency. Since a slice of cheese is not used in the present invention, there is no need for the consumer to use high energy to melt the cheese to cause it to spread and have the desired mouth texture. Consequently, the crustless cheese sandwich is merely microwave heated and then eaten. The internal cheese is melted by low energy and changes to the texture of a normal grilled cheese sandwich. This sandwich duplicates a homemade grilled sandwich, instead of a toasted sandwich.

In accordance with another aspect of the present invention, there is provided a frozen sandwich for commercial sales comprising a first portion of bread cut from a first slice of crusted bread. The first bread portion has an outer surface, a given periphery and a center area surrounded by a marginal area. A layer of masticated, plasticized unmelted cheese is deposited on the center area and spaced inwardly from the marginal area. A second portion of bread cut from a second slice of crusted bread and is placed over the first portion and the center layer of cheese. The second bread portion has an outer surface, periphery generally matching the periphery of the first portion and a marginal area generally matching and coextensive with the marginal area of the first portion of bread. The marginal areas are pressed together sufficiently to form a seal at the matching marginal areas. The surfaces of the bread portions are each heated to transform a thin skin into a toasted condition. In this manner, the sandwich is wrapped by a hermetically sealed package and frozen. The frozen sandwich is microwaved prior to consumption.

In accordance with another aspect of the present invention, there is provided a method and apparatus for producing the frozen crustless cheese sandwich. This method and apparatus involves a de-nesting mechanism, whereby a loaf of sliced bread is deposited on the de-nester and individual slices of bread are removed from the loaf and placed upon a moving platen. The platen is indexed by a belt conveyor to a position where a nozzle directs pumped masticated, plasticized cheese onto the bread. This method and apparatus uses a nozzle that deposits a flat layer of cheese. However, a rotating nozzle for depositing the cheese on the bread is used in an alternative embodiment of the invention. In accordance with another aspect of the invention, the cheese is forced from a large nozzle located directly over the bread slice. As the plasticized cheese oozes from the nozzle by an hydraulic pumping force, it is cut off and drops as a thin section on the bottom bread slice. Thus, the masticated, plasticized cheese is deposited onto the bread slice preparatory to being covered with a second bread slice. Thereafter the slices are cut to remove the crust and sealed by pressure in a shape around the center cheese deposit. The cutting and sealing action is taught by Kretchman U.S. Pat. No. 6,004,596. A cutter with a lower cutting edge cuts the bread slices against a lower surface. Then a ring presses the bread together by a force to seal the bread, but not compact the bread. There is little, if any, stretching of the bread with the adverse effect caused by stretched bread.

The invention has features applicable to making crustless peanut butter and jelly sandwiches. When making this type of sandwich, the invention of Kretchman U.S. Pat. No. 6,004,596 is employed. A layer of peanut butter receives a layer of jelly in a center area. Then a second layer of peanut butter covers the jelly and seals with the first layer around the jelly. This encapsulates the jelly by peanut butter to protect the bread from contact with the jelly having a high water activity.

The invention also involves improvements in the sandwich of Kretchman U.S. Pat. No. 6,004,596 to improve the sandwich and reduce the manufacturing cost. In one aspect, there is provided a method of mating a crustless sandwich using slices of bread from a circular crusted loaf of bread. Thus, when cutting the bread, a lesser amount of residue is generated. In accordance with another improvement, bread with the crust removed before processing is used to make the crustless sandwich. These improved sandwiches are made with a cheese layer using previously disclosed aspects of the invention or with a peanut butter and jelly layer using the Kretchman inventive concept of encapsulated jelly.

The first primary object of the present invention is the provision of a frozen sandwich that can be reconstituted by microwave into a grilled cheese sandwich with the taste, appearance and consistency of a homemade grilled cheese sandwich. A second primary object of the present invention is making a crustless sandwich having improvements over the pioneer invention in Kretchman U.S. Pat. No. 6,004,596.

Another object of the present invention is the provision of a frozen sandwich, as defined above, which frozen sandwich is hermetically packaged for commercial marketing.

Yet another object of the present invention is the provision of a frozen sandwich, as defined above, which frozen sandwich utilizes a center cheese filling in the form of a masticated, plasticized cheese deposited onto the sandwich either progressively as an unmelted cheese layer or as a section of cheese sliced and dropped onto the sandwich. Preferably, the masticated cheese is de-aerated before being deposited on the bottom bread slice.

Still a further object of the present invention is the provision of a novel method and apparatus for producing a frozen crustless cheese sandwich. This method and apparatus involves a de-nester and mechanism, for depositing cheese onto the first slice of bread preparatory to subsequent cutting and sealing of the bread into a crustless cheese sandwich. The sandwich simulates grilling by toasting only a thin skin by a heating process, which heating process does not deteriorate the inner cheese layer.

Another object of the present invention is the provision of a crustless grilled cheese sandwich, and method of making same, which sandwich includes plasticized cheese and a thin toasted layer or skin on the outer surfaces of the sandwich to limit heat distortion and absorption of the cheese during making of the sandwich and to simulate grilling of the bread.

Yet another object of the present invention is the provision of a method of making a grilled cheese sandwich, which method is also capable of producing a peanut butter and jelly sandwich wherein the peanut butter includes two spaced layers encapsulating a center layer of jelly.

Another object of the present invention is the provision of a frozen crustless cheese sandwich that is provided with a simulated grilled skin before freezing, so that it is reconstituted by a short heat cycle by a standard microwave.

These and other objects and advantages will become apparent from the following description taken together with the accompanying drawings.

### BRIEF DESCRIPTION OF DRAWINGS

FIG. 1 is a pictorial view of a crustless grilled frozen sandwich constructed in accordance with the present invention;

FIG. 2 is a top view of a bread slice with a superimposed nozzle for progressively depositing masticated, plasticized cheese in a circular pattern;

FIG. 3 is a cross-sectional view taken generally along line 3-3 of FIG. 2;

FIG. 4 is a side view, in cross-section, showing the cutter and sealing ring with the cutter in the cut position against a lower surface;

FIG. 5A is a view similar to FIG. 4 after the crustless sandwich has been cut and sealed with the sealing ring shown in the sealing position;

FIG. 5B is an enlarged segment of a crustless sandwich after the cut and seal operations of FIG. 4 and FIG. 5A;

FIG. 6A is a view similar to FIG. 5A showing a modification of the present invention;

FIG. 6B is a view similar to FIG. 5B illustrating a segment of the sandwich produced by the operations shown in FIG. 6A;

FIGS. 7A and 7B are schematic representations of prior art bread stretching cutters;

FIG. 8 is a pictorial view with a cross-sectional cut away area illustrating the preferred rectangular embodiment of the present invention;

FIG. 9 is a top view similar to FIG. 2 for the embodiment of the invention shown in FIG. 8;

FIG. 10 is an enlarged partial cross-sectional view schematically illustrating a feature of the sealing ring;

FIGS. 11A, 11B, 11C, 11D, and 11E are a schematic side view of the apparatus for making a frozen crustless grilled cheese sandwich in accordance with the invention;

FIGS. 12A, 12B, 12C, 12D, and 12E are enlarged cross-sectional view showing operation of a pumping mechanism similar to Powers U.S. Pat. No. 5,464,338 for masticated and plasticized cheese and forcing the cheese onto the first slice of bread preparatory to making a crustless cheese sandwich;

FIGS. 13A and FIG. 13B are progressive side views illustrating the depositing valve used in combination with the pumping mechanism shown in FIGS. 12A-12D for depositing a layer of masticated, plasticized cheese onto a first slice of bread;

FIG. 14 is a top view of the index conveyor used in accordance with the preferred embodiment of the invention illustrating the procedure for depositing cheese onto the first bread slice;

FIGS. 15A-15E are a series of progressive process views similar to FIG. 14 illustrating a sequential procedure for depositing cheese onto two parallel sets of bread slices moving in platens on an indexing conveyor in accordance with the preferred embodiment of the present invention;

FIG. 16A is an enlarged, cross-sectional view showing an apparatus and method for depositing masticated, plasticized cheese onto the first bread slice preparatory to making a crustless grilled frozen cheese sandwich and using the pumping concept of FIGS. 12A-12D;

FIG. 16B is a partially cross-sectional side view illustrating an alternative depositor of cheese;

FIG. 17 is a top view of the first slice of bread with a progressive nozzle used to deposit strips of cheese onto the bread slice in accordance with an alternative embodiment of the invention;

FIG. 18 is a top view of a grilled frozen cheese sandwich that is sealed and crimped in accordance with the present invention, but is not crustless;

FIG. 19 is an enlarged cross-sectional view taken generally along line 19-19 of FIG. 18;

FIG. 20A is a top view of a circular crustless sandwich using slices from a round loaf and having a center filling of peanut butter and jelly;

FIG. 20B is a cross-sectional view taken generally along line 20B-20B of FIG. 20A;

FIG. 21A is a top view of a crustless sandwich made from slices of crustless bread;

FIG. 21B is a cross-sectional view taken generally along line 21B-21B of FIG. 21A;

FIG. 22 is a top view similar to FIG. 18 showing a frozen grilled cheese sandwich made from crustless bread; and,

FIG. 23 is a cross-sectional view taken generally along line 23-23 of FIG. 22.

### PREFERRED EMBODIMENT

Referring now to the drawings, wherein the showings are for the purpose of illustrating preferred embodiments of the invention only and not for the purpose of limiting same, FIG. 1 shows a crustless frozen cheese sandwich A formed from a first cut bread portion 10 having a marginal area 10a and a second cut bread portion 12 with a marginal area 12a matching area 10a. The two bread portions are sealed at the marginal areas in a manner to provide a consistency around the sealed joint essentially duplicating the consistency of fresh bread. This sealing procedure is disclosed in Kretchman U.S. Pat. No. 6,004,596. When areas 10a, 12a are sealed together by compression, the force is not sufficient to form the complete peripheral joint into a homogeneous amorphous mass of dough as used by most prior crustless sandwiches. To accomplish this necessary objective, the two marginal areas are pressed together only to the extent necessary to adhere the bread, which is preferably fresh white bread with a 40-60% moisture content. Such fresh bread is sealed at the marginal areas to form seal 30, but still maintains two separate bread portions discernible by the visible dividing line 14. The bread portions are sealed together by pressure. To increase the mechanical holding force between the bread portions, spaced indentations 32 are created by mechanical projections on the lower surface of the sealing ring. These projections are formed by radially extending semi-cylindrical protrusions on the pressure sealing ring to be described later.

Sandwich A has surfaces 20, 22 which are toasted to produce a thin layer simulating a grilled condition on the outer surface of the bread. This rapid skin toasting is accomplished without distorting or causing heat to be convected into the center where cheese C is located. This crustless sandwich is thereafter packaged and frozen for sale in retail or in food service markets. A consumer merely allows sandwich A to thaw and then places it in a microwave oven at 50% heat for about 90 seconds. The cheese is heated and takes on the consistency of a grilled cheese sandwich.

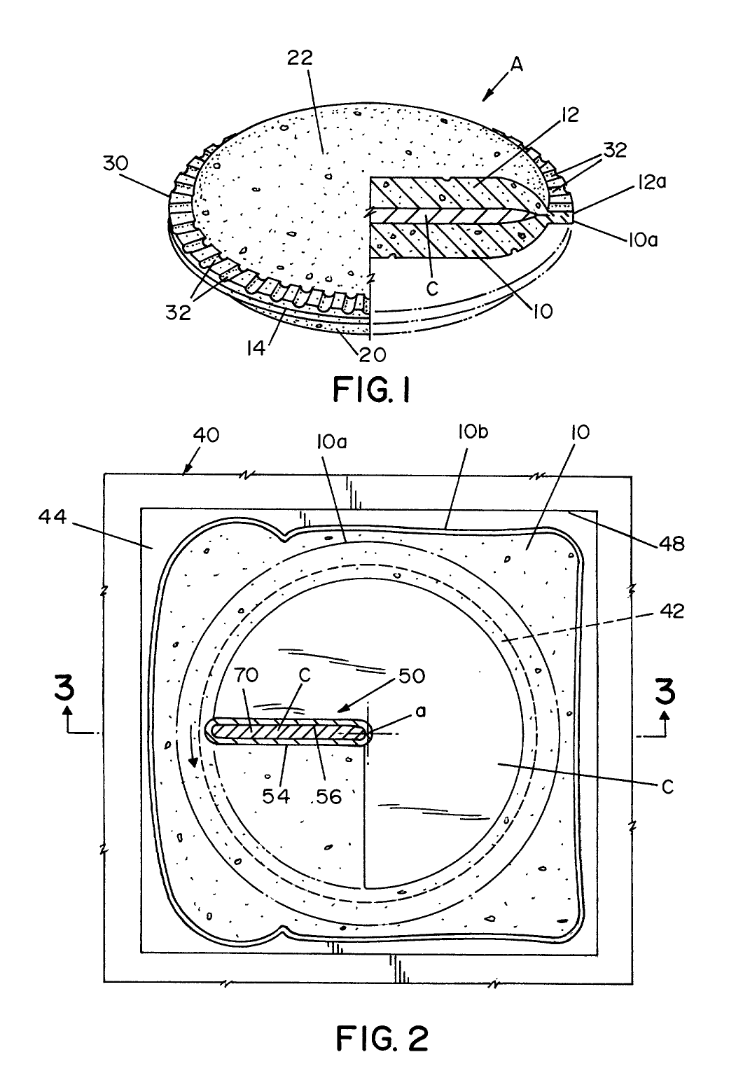

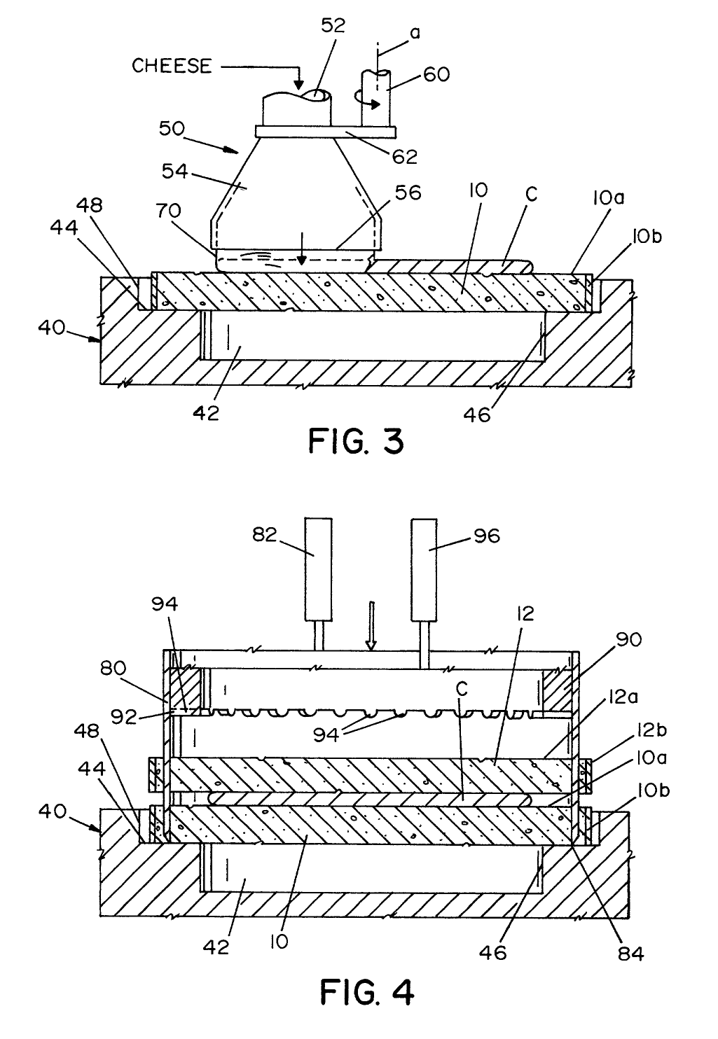

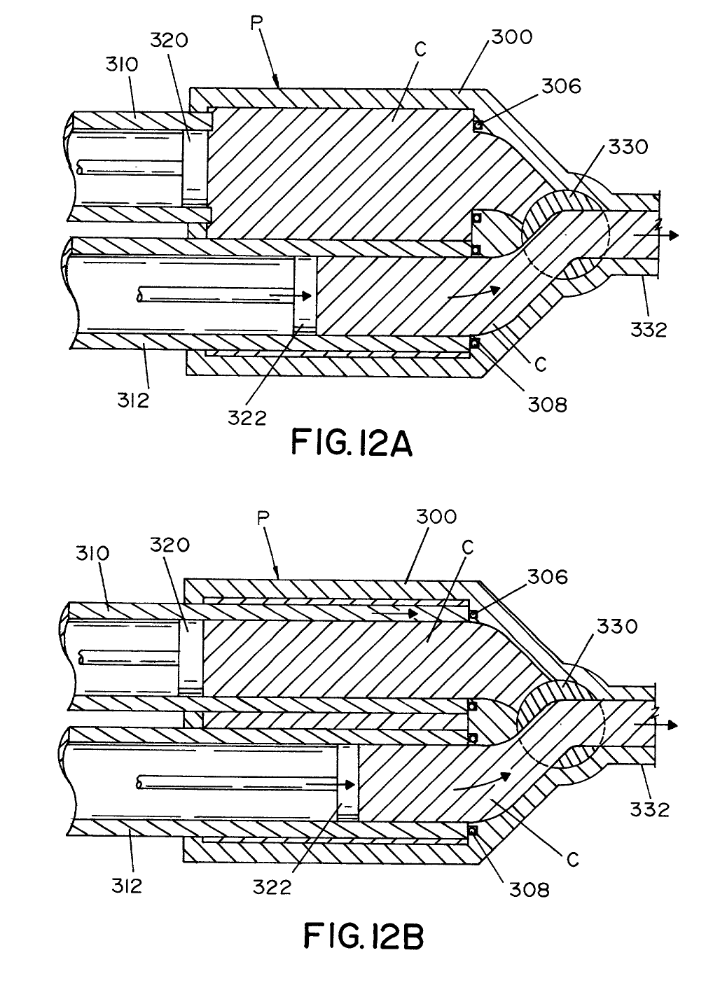

An apparatus for constructing crustless cheese sandwich A preparatory to subsequently (a) heating the skin of surfaces 20, 22, (b) hermetically packaging the sandwich and then (c) freezing the sandwich is disclosed schematically in FIGS. 2, 3, 4, and 5A. Platen 40 is movable and is conveyed through a process line as will be explained in connection with FIGS. 11A-11E. In the illustrated embodiment, a conveyor is indexed between positions. However, a method using a continuously moving conveyor is anticipated for future development. Platen 40 accepts bread slice 10 having an outer crust 10b. This first slice is laid over center recess 42, illustrated as a cylindrical depression within cutting ring surface 44 on shoulder 46. When making a circular sandwich A, center recess or depression 42 is circular and defines a circular cutting surface. Platen 40 has an outer perimeter 48 matching the outer shape of the crusted bread slice 10. This is best shown in FIG. 2. To produce the pre-grilled frozen crustless sandwich, masticated, plasticized cheese is deposited on marginal area 10a of slice 10 by a cheese depositor, such as depositor 50 shown in FIG. 3. Masticated, plasticized cheese is pumped to inlet 52 of depositor 50 for extrusion through nozzle 54 having an outlet opening 56, shown in FIG. 2 as an elongated orifice. Rotating shaft 60 turns an outboard support arm 62 for carrying nozzle 54 so cheese extrusion 70 is laid progressively in a circular mass by merely extruding a precise amount of cheese C as nozzle 54 is rotated about axis a. The plasticized cheese is provided by a Marlin OPTI model 280 food pump disclosed generally in Powers U.S. Pat. No. 5,465,338. A hopper accepts cheese chunks that are kneaded and then pumped through the outlet system, as shown in FIGS. 12A-12D. The pumped cheese is directed to inlet 52 of nozzle 54. In this manner, extruded cheese 70 is deposited in a circular layer within marginal area 10a of crusted bread slice 10. This operation is shown in FIGS. 2 and 3.

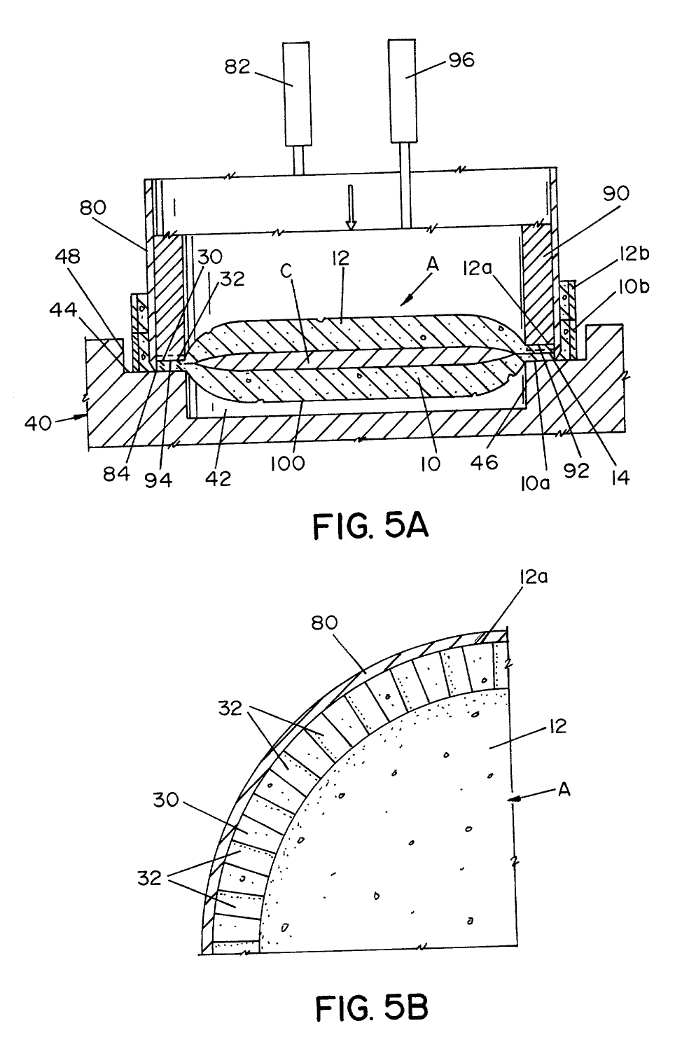

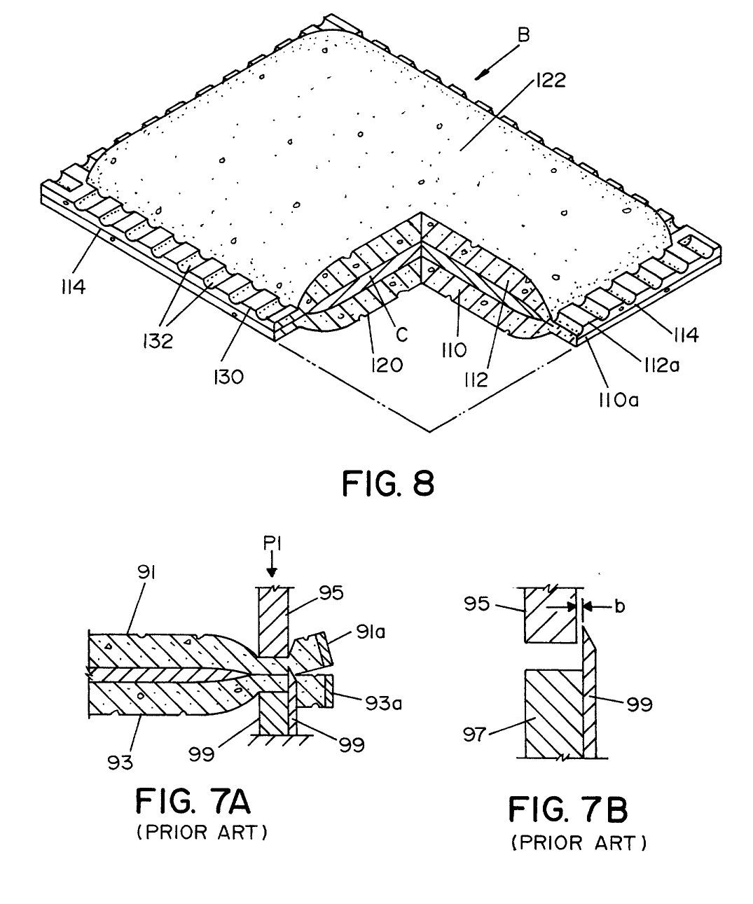

Turning now to FIGS. 4 and 5A, cutter blade 80 is formed in a circular shape to produce a circular sandwich, as shown in FIG. 1, a rectangular shape to produce a rectangular sandwich as shown in FIG. 8 or another appropriate shape such as a triangle to produce a triangular sandwich. The shape of blade 80 defines the outer perimeter of the crustless sandwich. In the illustrated embodiment of FIGS. 2-5A, the shape is circular and cutter blade 80 is forced downwardly by a driving mechanism 82, shown as an air cylinder, so that a lower cutting edge 84 cuts against surface 44 of platen 40. This provides a positive cut to remove the outer crust of bread slice 10. Before this cutting operation, a second bread slice 12, with marginal area 12a matching area 10a and crust 12b is laid over the deposited cheese layer. Thus, cutter blade 80, as it is forced downwardly by mechanism 82 cuts through both slices of bread in the same cutting action. This action is positive and clean because edge 84 engages surface 44. There is no tearing of the bread as caused by the cutting action used in Perrine U.S. Pat. No. 6,231,898. Such tearing action causes a stretching of the bread to destroy its fresh bread texture. Thus, the organoleptic characteristic of the outer perimeter is denigrated. The bread tearing action is shown in FIG. 7A. Crusted bread slices 91, 93 are pressed between rings 95, 97 while fixed blade 99 cuts with a scissor action with ring 95. This merely tears crust portions 91a, 93a away from the center portion of the slices. This causes the unwanted, undesired stretching and tearing of the bread. Furthermore, there is a necessary space b between blade 99 and ring 95. During the pressing action, the force can be discontinued before the cut is completed. This gives a defective cut. The sealing pressure is dictated by the cutting action and must compress the bread to the extent of depressions 32 of the invention. Otherwise, there is not assurance of long term bonding of the bread slices. All of these disadvantages are overcome by separating the cutting and sealing members and cutting against a hard flat surface as done in practicing the present invention. In summary, the positive cut against a surface does not have the deleterious result of the mechanism in Perrine U.S. Pat. No. 6,231,898. The positive cutting action removes not only the crust 12b, but also crust 10b from the crusted bread slices. This action requires a minimum amount of force and is effected by engagement of edge 84 with surface 44.

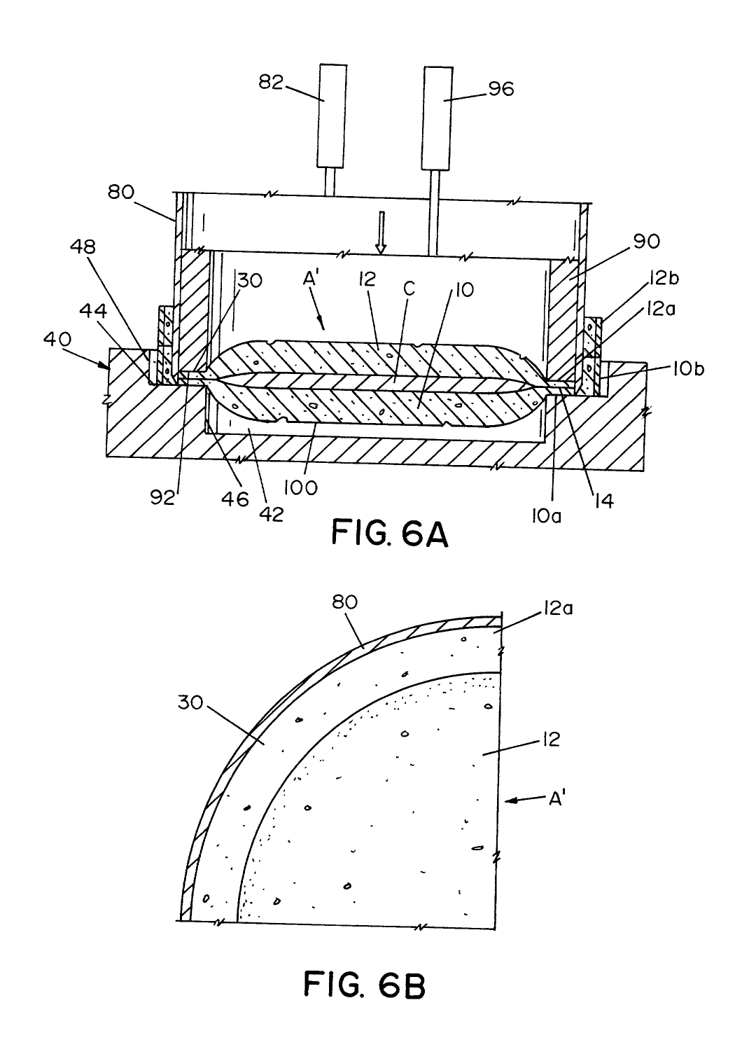

Turning again to the mechanism of FIGS. 5A and 6A, sealing ring 90, generally matching the inside of blade 80, is provided with a lower sealing rim 92 with spaced projections 94. These projections are semi-cylinders. After the cutting action, cylinder or drive mechanism 96 forces ring 90 against marginal areas 10a, 12a with sufficient pressure to join the overlying marginal areas due to the moisture content of the bread slices. By first cutting the bread slices with a knife cutting against a flat surface, the sealing action does not stretch the bread on either side of ring 90. Thus, the cutting action does not stretch the bread. In a like manner, the sealing action does not stretch the bread. In summary, the cut bread portions 10, 12 are sealed in a manner that there is no outside stretching of the bread. This produces a good organoleptic characteristic for the sealed edge 30 of sandwich A. During this sealing operation, the sandwich deforms into recess 42 to produce the curvilinear shape, as shown in FIG. 5A. In the past, the center of the lower bread slice was laid on a flat surface when the cut was against a surface. This combined flat support and cutting surface limited the final shape of the sandwich. By having the lower recess 42, body 100, constituting primarily bread, assumes the natural shape determined by the characteristics of the bread and the force and movement used during the sealing operation.

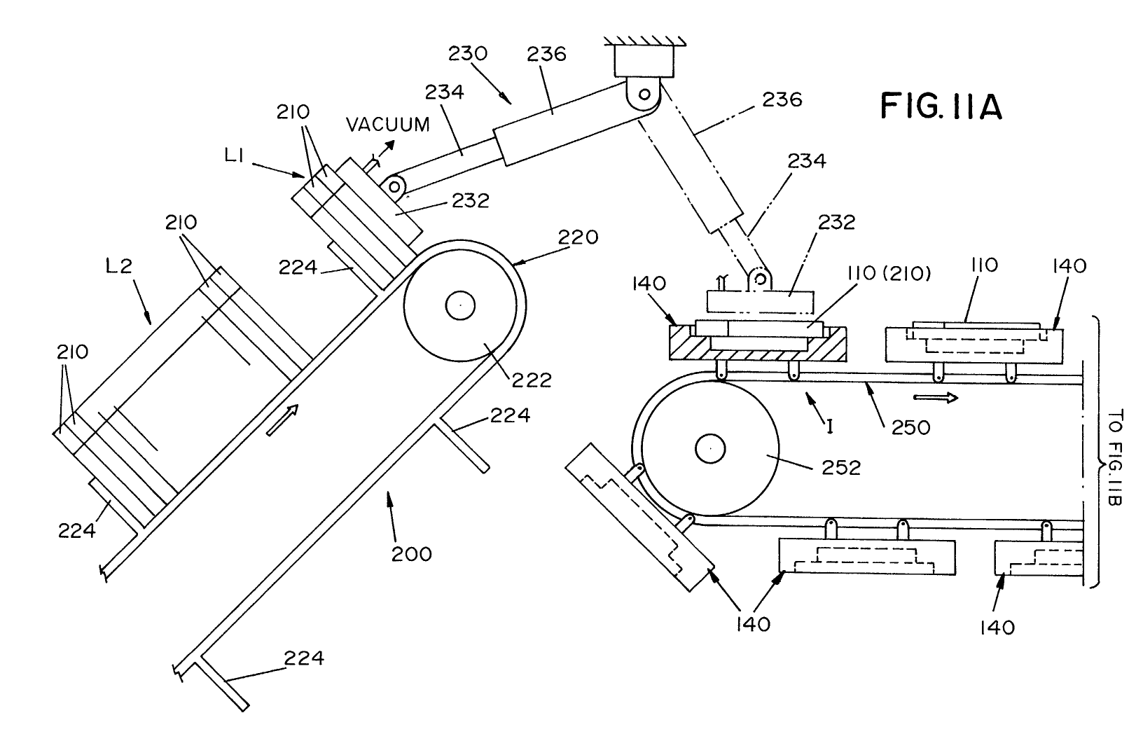

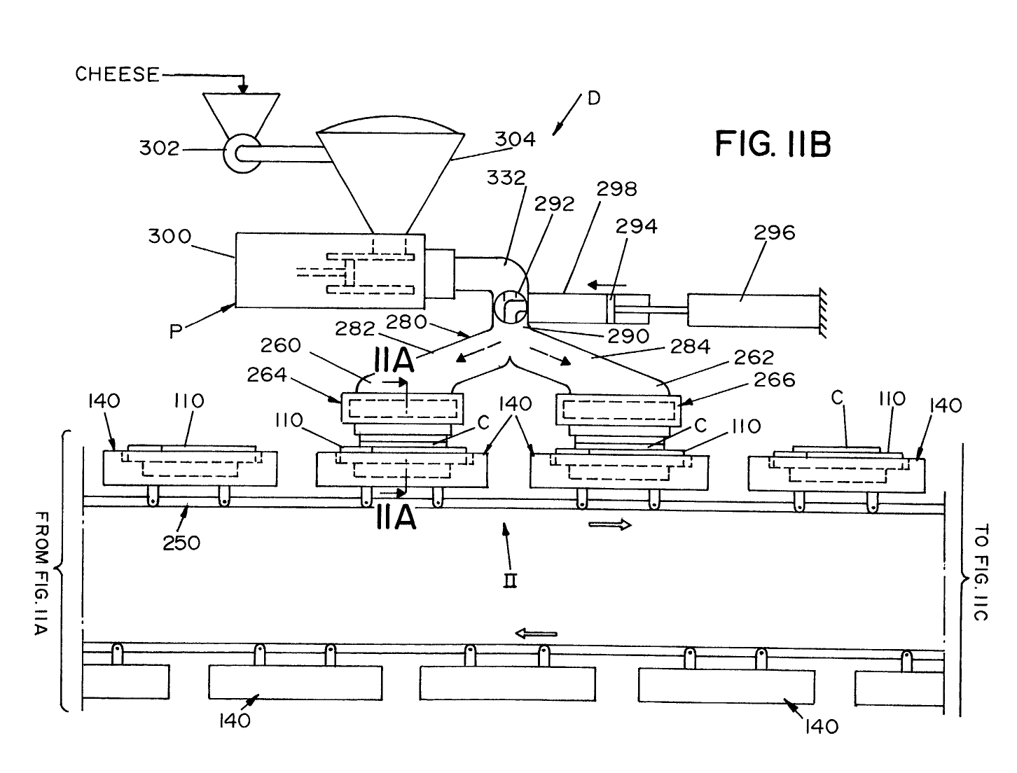

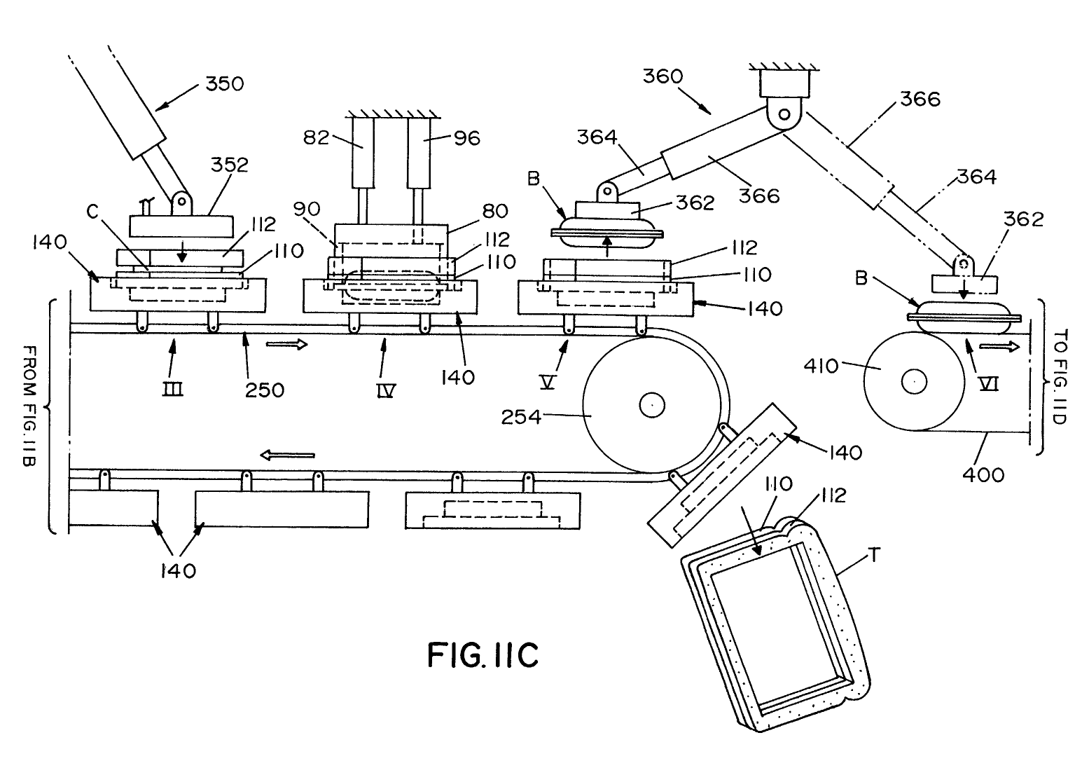

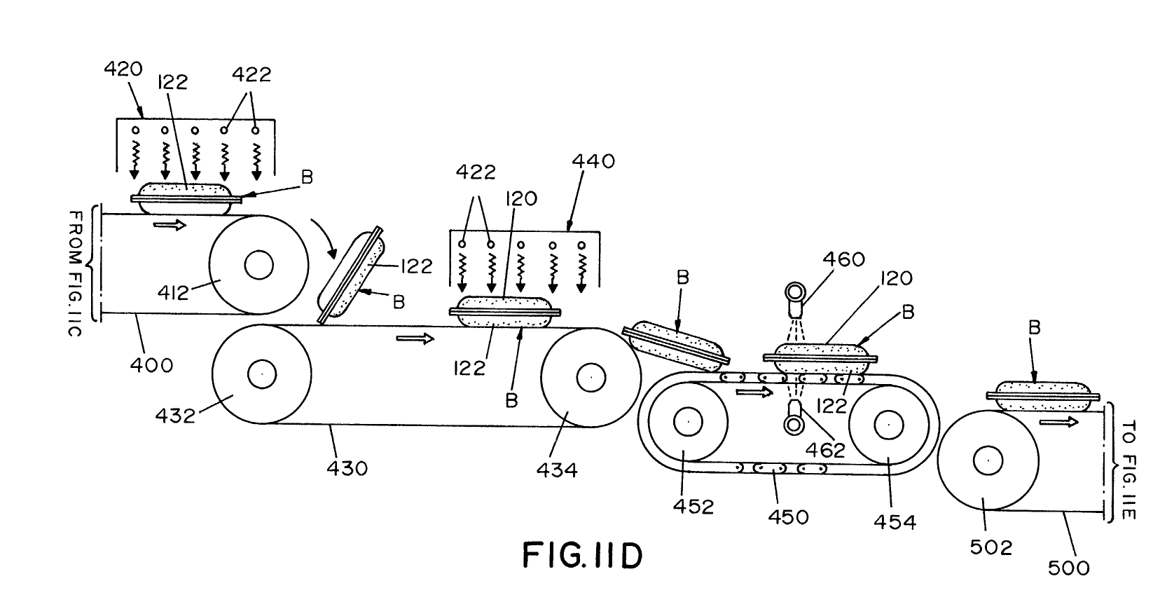

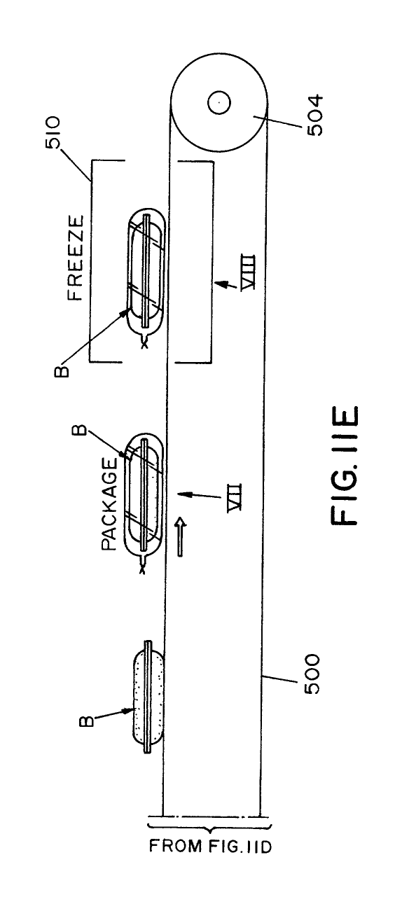

As shown in FIG. 5A, after the cutting operation has been accomplished, cutting edge 84 remains in place to define the outer periphery of the sandwich. Then, a separate compression action defines sealed edge 30. Projections 94 on the lower surface of ring 90 extend into the sealed edge to cause spaced semi-cylindrical indentations 32. These indentations are areas or locations of increased deformation of the bread primarily in upper portion 12. This mechanism positively joins the bread of edge 30 at spaced locations. The indentations extend toward marginal area 12a onto the generally flat upper surface of marginal edge 10a. These spaced indentations mechanically lock the bread while not distorting the bread edge 30. Indentations 32 are inside cutter blade 80 as shown in FIG. 5B. The action of projections 94 is schematically illustrated in FIG. 10 wherein semi-cylindrical indentations 32 in seal 30 cause small areas 30a where the bread is formed into an amorphous, homogenous mass to positively lock the seal 30 together at space locations corresponding to the locations of indentations 32. It has been found that below areas 30a the lower slice 10 has compress recesses 30b so that the lower portion of slice 10 reveals markings in line with indentations 32. As can be seen in FIG. 10, indentations 32 primarily distort slice 12 into seal or joint 30 to lock the seal together. Slice 10 is not drastically distorted. This gives a pleasing appearance and maintains the natural bread texture, even during and after freezing.

Turning now to the embodiment shown in FIG. 6A, the cutting and sealing mechanisms are essentially the same as the prior embodiment. However, lower pressure ring 92 is flat without projections 94. Consequently, the bread seal of crustless sandwich A′ does not include indentations 32 or the areas 30a or recesses 30b as shown in FIG. 10. A segment of the sandwich shown in FIG. 6A is illustrated in FIG. 6B.

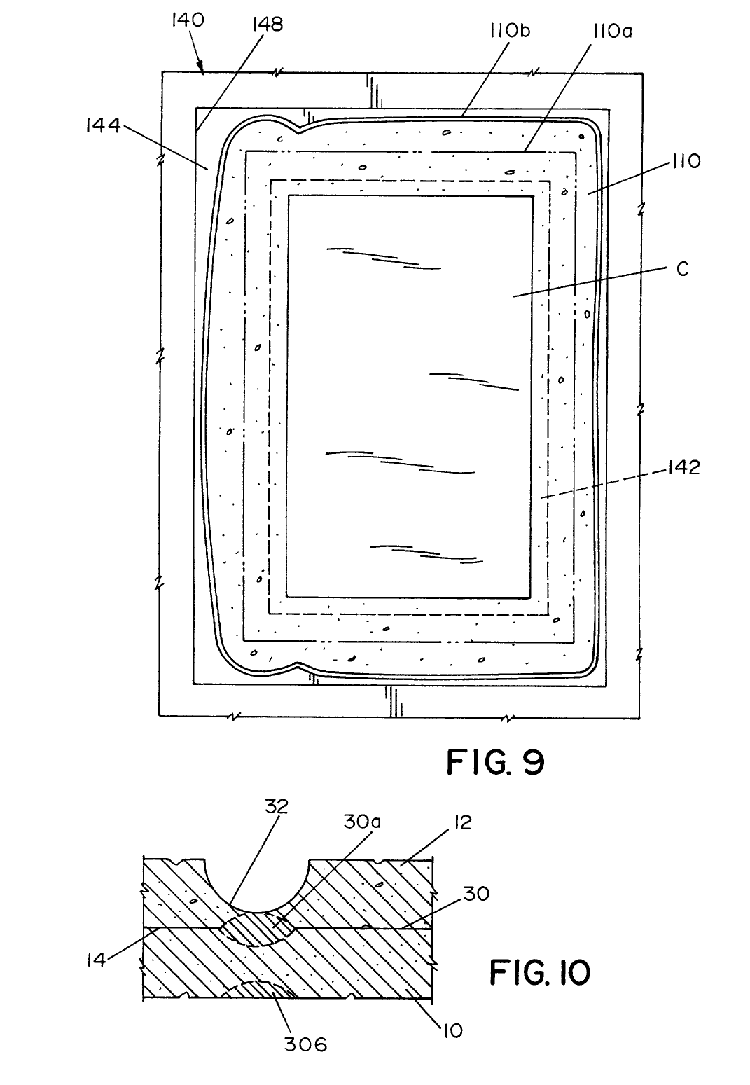

A rectangular frozen crustless pre-grilled cheese sandwich B is shown in FIG. 8. The sandwich includes a first bread portion 110 and a second bread portion 112 having marginal edges 110a, 112a, respectively. As shown in FIG. 8, dividing line 114 indicates that the two bread portions in the marginal areas are not compressed into a amorphous indistinct dough as in the prior art. Natural bread consistency is retained. The skin of surfaces 120, 122 is toasted to simulate grilling. A rectangular sealed edge 130 has indentations 132 and joins marginal areas 110a, 112a, respectively. As shown in FIG. 9, lower platen 140 is similar to platen 40 of FIG. 3, but has a rectangular shape instead of a circular shape. Platen 140 has a lower rectangular recess 142 around which is located flat cutting surface 144. This flat surface coacts with an appropriate rectangular cutter blade, not shown, to cut bread portions 110, 112 preparatory to a compression seal by an appropriate rectangular sealing ring also not shown. This ring and cutter blade have the structure generally shown in FIGS. 4, 5A and 6A. Crustless sandwich B is essentially the same as sandwich A, but has a rectangular shape. To accommodate the shape, perimeter 148 of platen 140 is generally rectangular.

The apparatus to make rectangular cheese sandwich B is essentially the same as the apparatus for making sandwiches A, A′. Consequently, the apparatus to make sandwich B will be described in detail and this description will apply equally to the other shaped sandwiches. In FIGS. 11A-11E the production line for making sandwich B is disclosed. As shown in FIG. 11A, de-nester station 200 removes individual bread slices from loaf L1 containing the bread slices being dispensed. Loaf L2 contains bread slices awaiting de-nesting. Bread slice 210 is removed from loaf L1 for use as the bottom bread slice 110 in sandwich B. The de-nester includes an inclined indexing conveyor 220 having end guide rollers 222, only one of which is shown. Pusher plates 224 push the bread loaves upwardly toward pick and place device 230. This pushing action is indexed to bring a first slice of bread 210 to vacuum head 232 of device 230. The device includes a rod 234 operated by cylinder 236. Device 230 captures slice 210 by vacuum head 232. Then cylinder 236 retracts rod 234 and moves the vacuum head to the position shown in phantom lines in FIG. 11A. Then, rod 234 places slice 210 onto platen 140 as first slice 110 described in FIGS. 8 and 9. Platen 140 is carried on conveyor 250 indexed around roller 252 shown in FIG. 11A and roller 254, shown in FIG. 11C. After a slice 210, i.e. slice 110, is deposited on platen 140 at location I, inclined conveyor 220 indexes the thickness of a bread slice and conveyor 250 indexes to the right as shown by the arrow in FIG. 11A. This index action brings a new platen 140 into the pick and place deposit position I. As will be discussed later, there are two side-by-side rows of platens 140 on conveyor 250. Thus, there are two pick and place devices 230, one servicing each set of platens. At location I, a slice is deposited by pick and place device 230 on both side-by-side platens 140. In the illustrated embodiment, conveyor 250 is an indexing conveyor. This is necessary if the deposit and/or cutting and sealing are at fixed locations. Otherwise, the conveyor could be continuously moved with coordinated deposition, cutting and sealing.

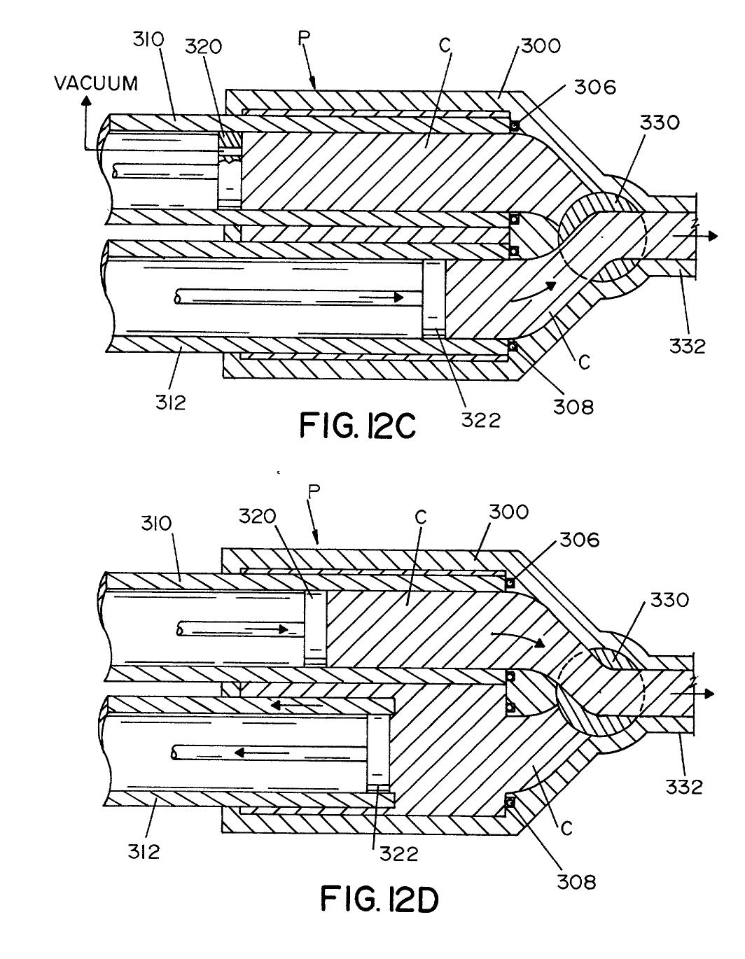

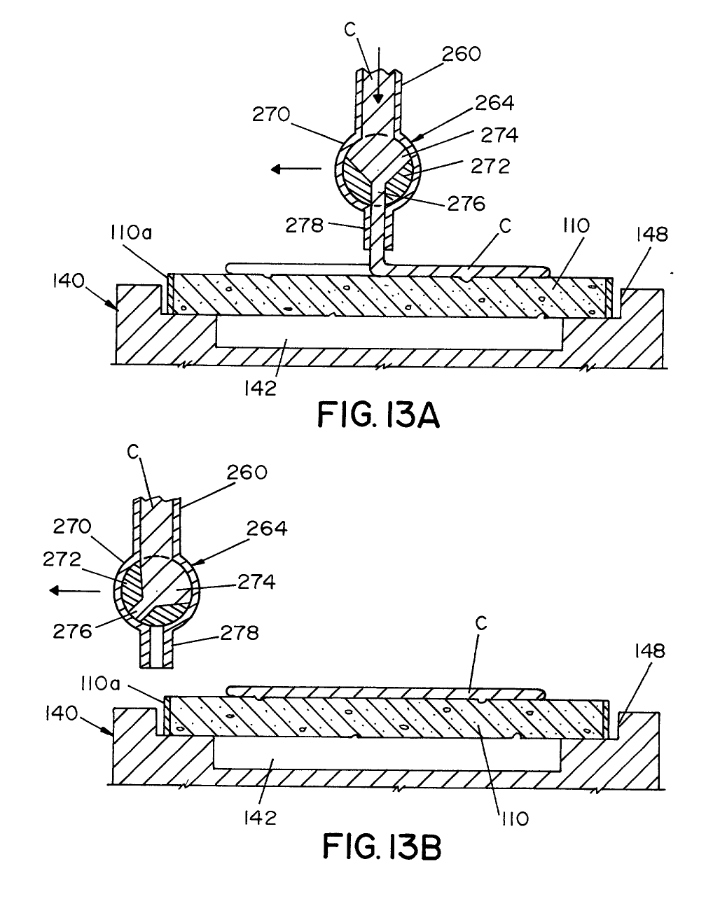

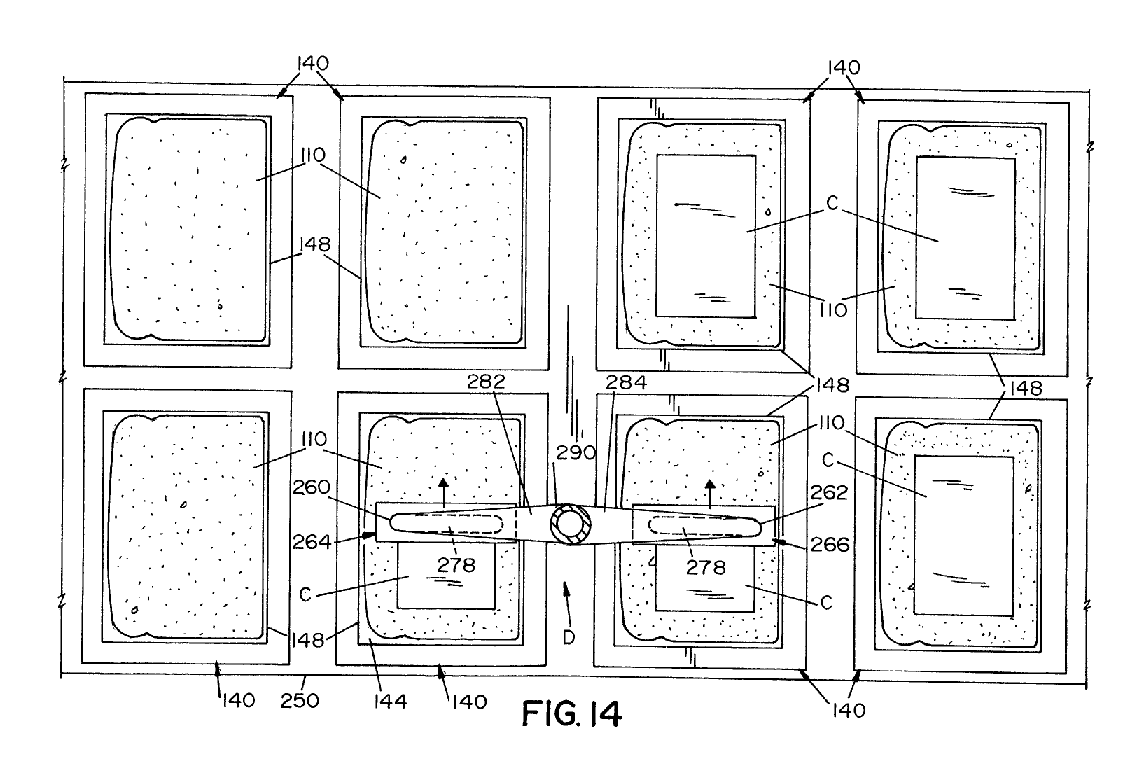

In FIG. 11B, cheese depositor D includes longitudinally spaced tool nozzles 260, 262, best shown in FIG. 14. These nozzles include longitudinally extending cylindrical rotary valves 262, 266, respectively. Only one cylindrical rotary valve 264 is shown in FIGS. 13A, 13B. A description of this cylindrical valve will apply equally to cylindrical valve 266 spaced longitudinally of conveyor 250, as illustrated in FIGS. 11B and 14. Each cylindrical valve has a body 270 with a rotary cylindrical element 272 having a large inlet slot 274 and a narrow outlet slot 276. This outlet has a shape generally corresponding with elongated slot 278 located above bread slice 110, as shown in FIGS. 13A, 13B. When cheese C is to be deposited on the center of slice 110 in a rectangular pattern, as shown in FIG. 14, rotary element 274 is open so cheese C is progressively deposited in a flat layer by nozzles 260, 262 moving in unison across adjacent bread slices. This is best shown in FIG. 14. At the end of the cheese deposit step, valve element 274 is rotated as shown in FIG. 13B cutting off the cheese. This progressive depositing of cheese C is distinguished from the rotary progressive deposit of cheese C as shown in FIG. 3. FIG. 3 relates to a circular sandwich while FIGS. 13A, 13B relate to a rectangular sandwich. To feed cheese C into nozzle 260 there is a feed manifold 280 shown in FIG. 11B. Manifold 280 includes branches 282,284 and receives cheese from inlet 290 by way of feed valve 292. This valve is in the position shown in FIG. 11B when exhaust piston 294 is operated by cylinder 296 for forcing cheese from chamber 248 into the manifold where it is directed to branches 282, 284 for use by rotary valve 264, 266, respectively. In this manner, dual nozzles 260, 262 are provided with pressurized, masticated, plasticized cheese forced into the manifold by pneumatic cylinder 296. A Marlin pump is used to provide cheese that has been de-aerated to valve 292. The Marlin pump operation shown in Powers U.S. Pat. No. 5,464,338 is schematically illustrated in FIGS. 12A-12B. Pump P includes a housing 300 to receive cheese from grinder 302 and vacuum hopper 304 shown in FIG. 11B. The feedstock cheese is preferably chunks, but it could be slices or even melted cheese. The cheese is masticated and plasticized before being pumped. The pumping can assist in plasticizing the cheese.

Details of housing 300 are shown in FIGS. 12A-12D. The housing has side-by-side chambers with end O-ring seal 306, 308 and spaced movable sleeves 310,312 working in concert with pistons 320,322, respectively. Directional rotary outlet valve 330 has an outlet tube 332. This tube directs pressurized cheese to rotary valve 292. When the feed valve is in the dotted line position shown in FIG. 11B, cylinder 296 retracts piston 294 to allow pump P in FIGS. 12A-12D to force cheese into chamber 298 in front of piston 294. Then valve 292 is rotated to the solid line position so cylinder 296 forces cheese into nozzle 280 through branches 282, 284 into valve spaced nozzles 260, 262, respectively. Pump P is standard food processing equipment sold by Marlin. Its operation is well known; however, the operation is schematically illustrated in FIGS. 12A-12D. As piston 322 is forcing cheese captured by sleeve 312 through valve 330, cylinder 310 and piston 320 are both retracted. This allows loading of housing 300 in front of sleeve 310. As piston 322 continues forward to force pressurized cheese through tube 332, cheese is captured by forward movement of sleeve 310 to a position engaging O-ring seal 306. This is illustrated in FIG. 12B. Thereafter, piston 322 continues exhausting the cheese in front of this piston and captured by sleeve 312. Piston 320 pressurizes cheese C to extract air through a vacuum exhaust behind piston 320. This is illustrated in FIG. 12C. Thereafter, the reverse pumping procedure is sequenced. Piston 320 forces cheese through valve 330 rotated to the position shown in FIG. 12D. At the same time, piston 322 and sleeve 312 are retracted to load the chamber in front of these components with masticated, plasticized cheese. This action of the two sets of pistons and sleeves causes a continuous delivery of pressurized, masticated cheese from tube 332 to the dispensing chamber 298 in front of piston 290. By this action, dispenser D forces two layers of cheese C on the laterally spaced bread slices carried by two platens on conveyor 250, as best shown in FIG. 14. As shown in FIG. 11B, cheese depositor D operates on two adjacent platens 140 at location II. The platen carrying a bread slice with a cheese layer is then indexed to position III shown in FIG. 11C. At this position a second pick and place device 350 with a vacuum head 352 captures slice 112 from a denester 200 of the type shown in FIG. 11A. This completes the assembly of food components onto platen 140. The platen is then indexed to position IV to be cut and sealed as described in connection with FIGS. 4 and 5A. This produces a sandwich B having a construction as shown in FIG. 8. Thereafter, conveyor belt 250 is indexed to bring the platen and sandwich B to position V. At this position, third pick and place device 360 with a vacuum head 362, rods 364 and operating cylinder 366 captures sandwich B and places the sandwich on belt conveyor 400 at deposit position VI. As belt 250 indexes, the residual bread crust T is dropped into a disposition bin or hopper. Belt conveyor 400 supported by spaced guide rollers 410,412, moves the sandwich B from position VI through radiant heater 420 with heating elements 422. This toasts the outer skin of surface 122 without toasting bread slice 112. Surface 122 has a simulated grilled condition. A lower conveyor 430 is positioned to flip sandwich B as shown in FIG. 11D. This exposes surface 120 as sandwich B is conveyed through radiant heater 440 having heating elements 442. This toasts a thin outer layer of surface 120 so that both surfaces 120, 122 have a simulated grilled condition and appearance. Thereafter, continuous movement of the conveyor 430 transfers sandwich B onto open grid belt conveyor 450 continuously driven around rollers 452, 454. This moves sandwich B between sprays 460, 462 to spray a margarine or butter flavored oil onto both surfaces 110, 112. This spray material adds flavor and color to the sandwich. After the spraying operation, sandwich B is transferred to indexing belt conveyor 500 where the sandwich is indexed to an overwrap packaging operation at position VII and into a quick freezer 510 at position VIII. Thereafter, the packaged frozen sandwich B is placed in containers for retail or food service trade. Although the apparatus and method has been explained with respect to a rectangular sandwich B, circular sandwiches A, A′ could be made in accordance with the same method using essentially the same apparatus. The difference would be the type of masticated, plasticized cheese C pressurized by pump P. A rotary dispenser is used to provide cheese from pump P to a circular sandwich as shown in FIG. 1.

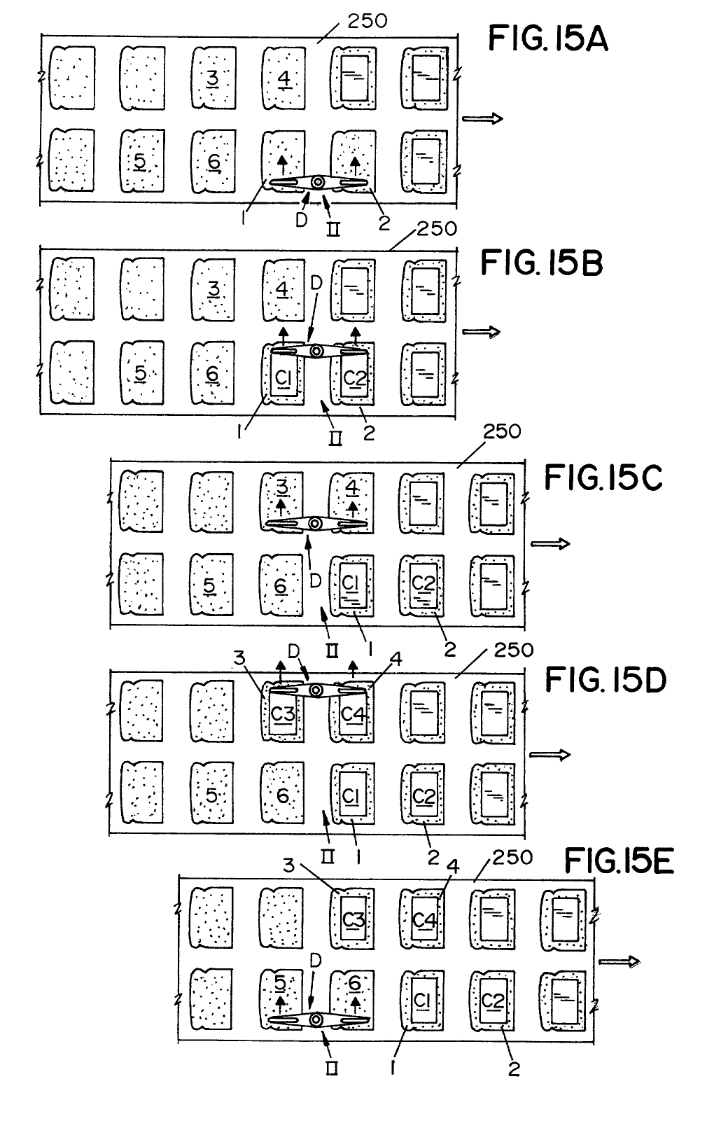

One sequencing operation of dispenser D is show in FIGS. 15A-15E. Bread slices 1 and 2 are indexed to the position II as shown in FIG. 15A. Dispenser D is at the lower edge of slices 1, 2. Dispenser D progressively lays layers of cheese C1 and C2 onto slices 1, 2, respectively. Thereafter, belt 250 indexes bringing slices 3, 4 to position II. This is shown in FIG. 15C. Dispenser D then moves forward, as indicated by the arrows, to deposit layers of cheese C3, C4 on slices 3, 4, respectively. This is shown in FIG. 15D. Belt 250 is again indexed so that dispenser D is ready to deposit a layer of cheese on bread slices 5, 6. This sequencing continues as belt 250 indexes one position at a time between each movement of the dispenser D to deposit a cheese layer on longitudinally spaced bread slices in spaced platens 140.

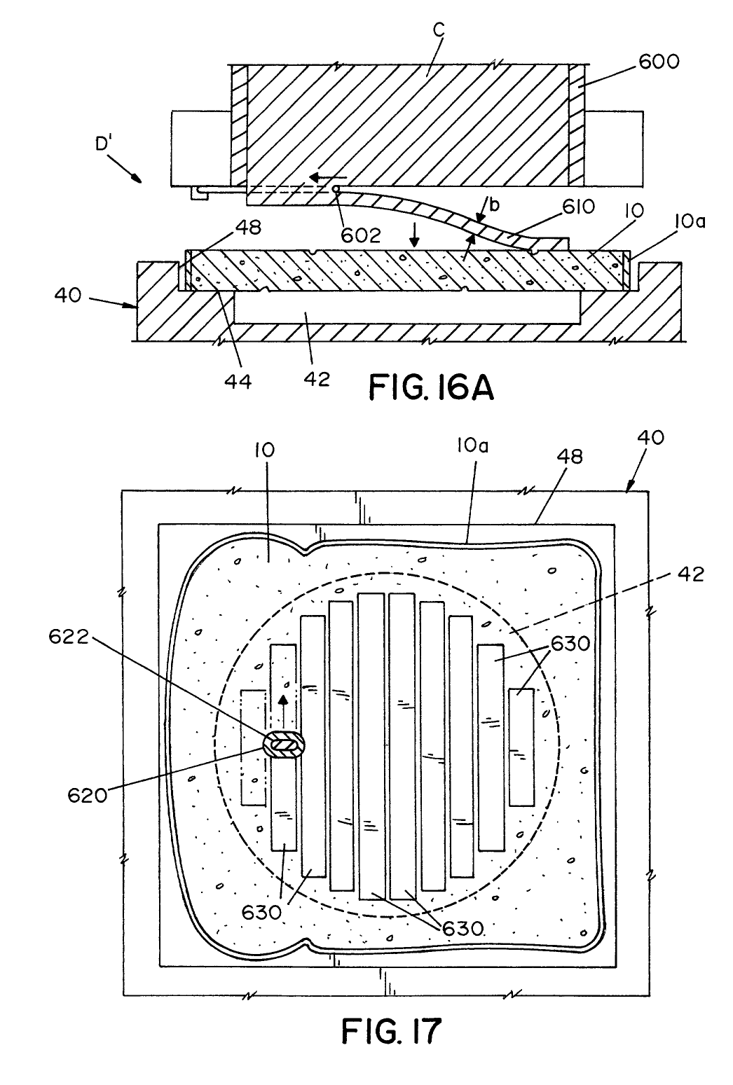

In accordance with another preferred embodiment of the invention, masticated, plasticized cheese is forced by pump P and cylinder 296 through a nozzle 600 having the cross-sectional shape of the final deposited layer of the cheese. Dispenser D′ is shown in FIG. 16A wherein the cheese is forced progressively through nozzle 600 to provide a section 610 that is cut by wire 602, like a guillotine cutter. This produces a section that has a thickness b that is dropped onto slice 10 located on platen 40. Of course, the bread could be slice 110 on platen 140 if the nozzle 600 were generally rectangular in cross-section. In this manner, a single section of plasticized cheese, which is different than a slice of processed cheese, is deposited onto the first slice of bread preparatory to producing a crustless, grilled frozen cheese sandwich. Another dispensing procedure is shown in FIG. 17 wherein nozzle 620 has an opening 622. Parallel stripes 630 in any selected pattern are deposited by progressively moving nozzle 620 in parallel paths across the surface of bread slice 10 under control of a microprocessor. Of course, if a rectangular pattern of parallel stripes were desired, a nozzle similar to 278 with spaced openings is used. All of these arrangements for depositing cheese C onto the bread preparatory to making a crustless sandwich are within the intended scope of the present invention.

To provide masticated, plasticized cheese to nozzle 600 shown in FIG. 16A, the mechanism shown in FIG. 16B has been provided. A depositor by Vemag Maschinenbau GmbH of Verden, West Germany includes hopper 650 to masticate cheese chunks 652 for feeding into a double screw pressurizing tube 660 with screws driven by motor 662. The plasticized cheese is forced under pressure through nozzle 600 to be cut off by cutter 602 as previously described.

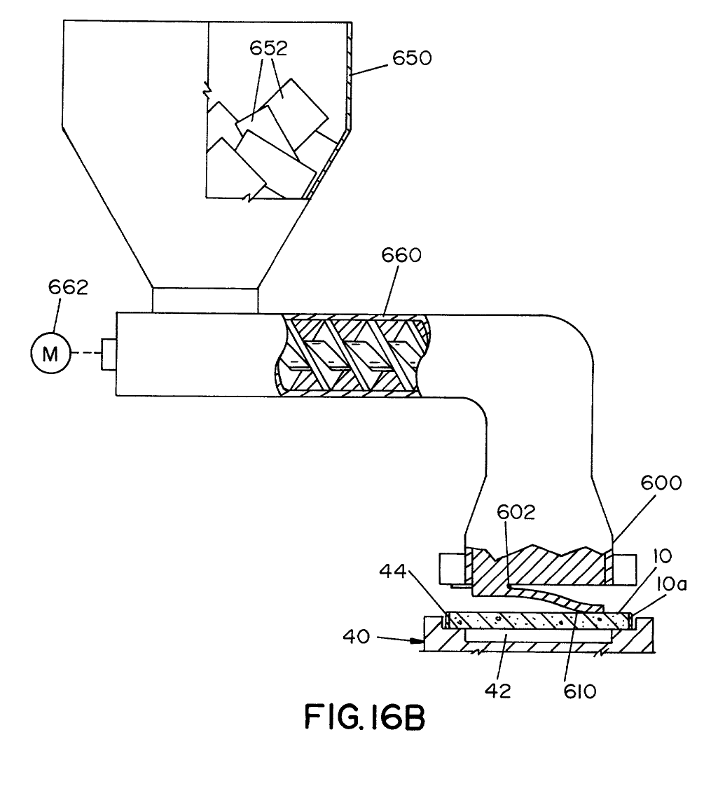

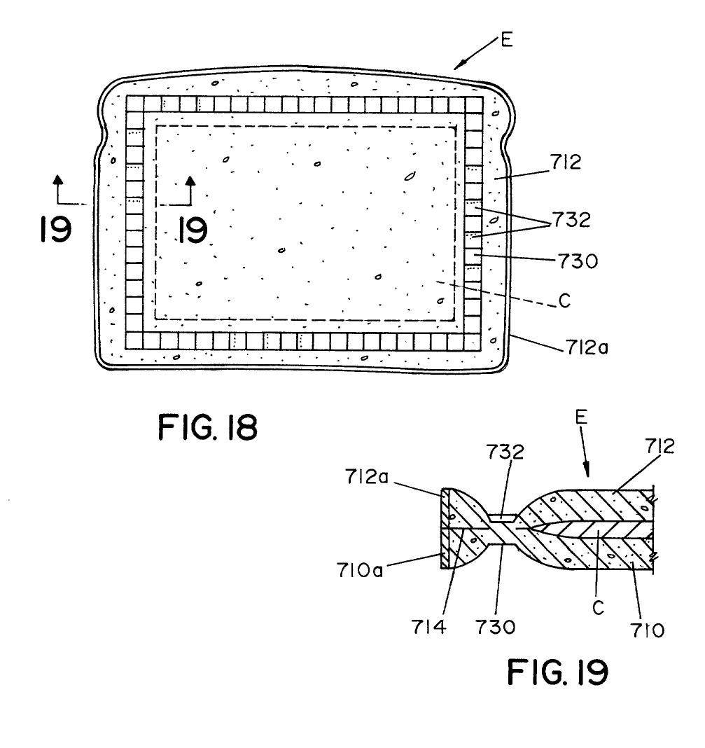

Although the present invention relates to a crustless sandwich, the use of a masticated, plasticized cheese C in a sealed crusted sandwich is shown in FIGS. 18 and 19. Sandwich E is formed by spaced bread slices 710, 712 between peripheral crusts 710a, 712a, respectively. These two bread slices are pressed together at peripheral seal 730 surrounding the cheese. Dividing line 714, as shown in FIG. 19, clearly shows the two bread slices. Peripheral seal 730 is made with a sealing ring 90 as shown in FIG. 4. The sandwich is not cut prior to sealing. This is the distinction with respect to the preferred embodiment of the present invention. Thus, the dispensing procedure of the invention and the subsequent method acts of the invention, except for the cutting action, are used in making the crusted sandwich E.

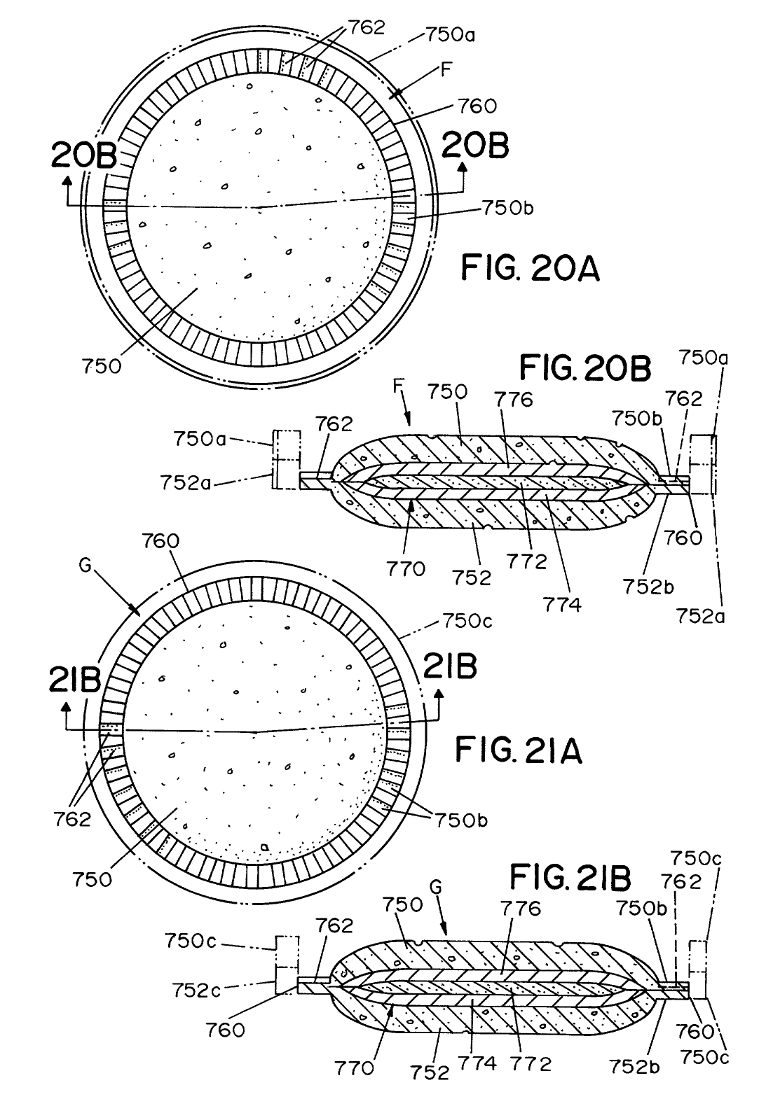

To reduce the amount of scrap, circular crustless sandwich F as shown in FIGS. 20A, 20B is made from bread slices 750,752 formed from a bread loaf having a circular crust 750a, 752a. The crusted circular bread slices are cut along periphery 760 and sealed at marginal areas 750b, 752b with indentations 762. The filling is either cheese, not shown, or a peanut butter and jelly layer 770 with jelly 772 encapsulated by lower peanut butter layer 774 and upper peanut butter layer 776. Sandwich G in FIGS. 21A and 21B is the same as sandwich F, except the slices 750 and 752 are from a crustless round loaf of bread. Thus, edges 750c, 752c are not crusts.

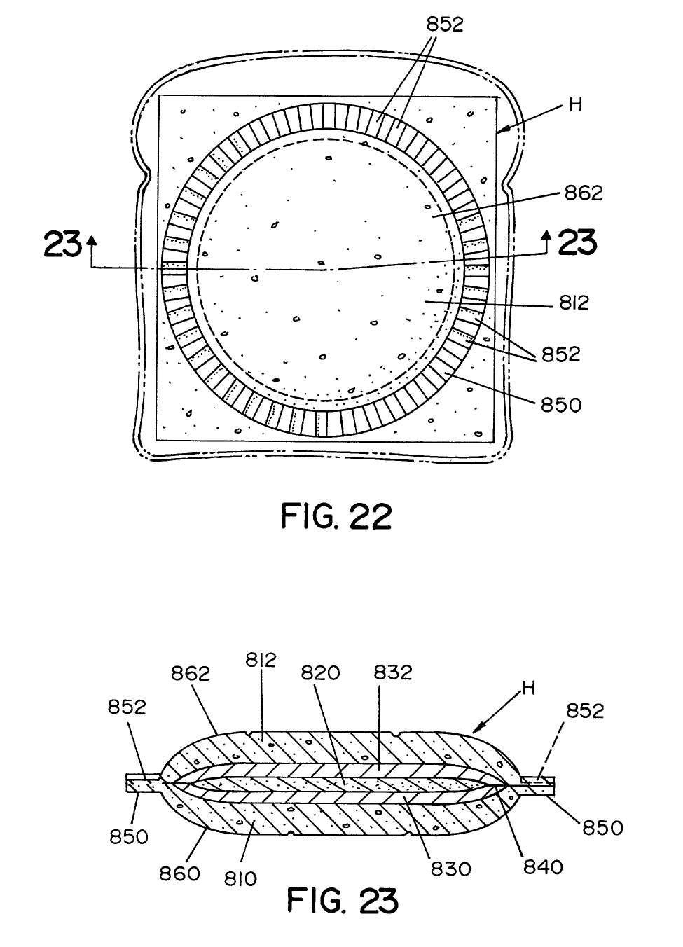

In accordance with abroad application of the invention, like sandwich G, crustless sandwich H in FIGS. 22 and 23 is produced by two slices 810, 812 of crustless bread. The bread is cut from a loaf with the shape shown in phantom lines. This sandwich has either a cheese filling or a peanut butter and jelly filling as shown in FIG. 23. Using the concept of Kretchman U.S. Pat. No. 6,004,596, a layer of jelly 820 is encapsulated between two layers 830, 832 of peanut butter surface sealed around the jelly layer at periphery 840. A generally circular seal 850 employs spaced pressure points 852 to increase the holding force of the peripheral seal. Otherwise, the slices 810, 812 are adhered by the adhesive characteristic of bread with a moisture content of 20%-60%. Sandwich H does not have the extra bread removed; however, the sandwich is alternatively made with the apparatus show in FIG. 4 where the bread slices are cut around and with a pattern matching the shape of surface seal 850. When the filling is cheese, which could be a mere slice of processed cheese, the outer skins of surfaces 860, 862 are toasted before packaged and sealed, with or without the extra bread being removed.

Structure and features of the various embodiments can be combined to produce a sandwich with crust, without crust and/or with or without extra bread when using a crustless bread. The filling, if applicable, can be cheese or peanut butter and jelly in the encapsulated structure of FIGS. 20B, 21B, and 23.

Having thus defined the invention, the following is claimed:

1. A frozen sandwich for commercial sales comprising a first portion of bread cut from a first slice of crusted bread, said first portion having an outer surface, a given periphery and a center area surrounded by a marginal area; a layer of masticated, plasticized cheese deposited on said center area and spaced inwardly from said marginal area; a second portion of bread cut from a second slice of crusted bread and overlying said first portion and said layer of cheese, said second portion having an outer surface, a periphery generally matching said periphery of said first portion and a marginal area generally matching and coextensive with said marginal area of said first portion; said marginal areas being compressed together to form a seal generally matching said peripheries of said bread portions; said outer surfaces of said bread portions being heat scorched to transform a thin skin of said portions into toasted bread; and, said cheese layer being progressively deposited on said first portion.

2. A frozen sandwich as defined in claim 1 wherein said peripheries are circular.

3. A frozen sandwich as defined in claim 2 wherein said seal includes spaced crimped indentations.

4. A frozen sandwich as defined in claim 1 wherein said seal includes spaced crimped indentations.

5. A frozen sandwich as defined in claim 1 wherein said sandwich is encapsulated in a hermetically sealed package.

6. A frozen sandwich as defined in claim 5 wherein said cheese layer has a thickness in the general range of ⅛-¼ inch.

7. A frozen sandwich as defined in claim 4 wherein said cheese layer has a thickness in the general range of ⅛-¼ inch.

8. A frozen sandwich as defined in claim 3 wherein said cheese layer has a thickness in the general range of ⅛-¼ inch.

9. A frozen sandwich as defined in claim 2 wherein said cheese layer has a thickness in the general range of ⅛-¼ inch.

10. A frozen sandwich as defined in claim 1 wherein said cheese layer has a thickness in the general range of ⅛-¼ inch.

11. A frozen sandwich for commercial sales comprising a first portion of bread cut from a first slice of crusted bread, said first portion having an outer surface, a given periphery and a center area surrounded by a marginal area; a layer of masticated, plasticized cheese deposited progressively on said center area and spaced inwardly from said marginal area; a second portion of bread cut from a second slice of crusted bread and overlying said first portion and said layer of cheese, said second portion having an outer surface, a periphery generally matching said periphery of said first portion and a marginal area generally matching and coextensive with said marginal area of said first portion; said marginal areas being compressed together to form a seal generally matching said peripheries of said bread portions; said outer surfaces of said bread portions being heat scorched to transform a thin skin of said portions into toasted bread; and, said cheese layer being progressively deposited on said first portion.

12. A frozen sandwich as defined in claim 11 wherein said peripheries are circular.

13. A frozen sandwich as defined in claim 12 wherein said seal includes spaced crimped indentations.

14. A frozen sandwich as defined in claim 11 wherein said seal includes spaced crimped indentations.

15. A frozen sandwich as defined in claim 11 wherein said sandwich is encapsulated in a hermetically sealed package.

16. A frozen sandwich as defined in claim 15 wherein said cheese layer has a thickness in the general range of ⅛-¼ inch.

17. A frozen sandwich as defined in claim 14 wherein said cheese layer has a thickness in the general range of ⅛-¼ inch.

18. A frozen sandwich as defined in claim 13 wherein said cheese layer has a thickness in the general range of ⅛-¼ inch.

19. A frozen sandwich as defined in claim 12 wherein said cheese layer has a thickness in the general range of ⅛-¼ inch.

20. A frozen sandwich as defined in claim 1 wherein said cheese layer has a thickness in the general range of ⅛-¼ inch.

21. A frozen cheese sandwich as defined in claim 15 wherein said cheese layer is a flat single mass.

22. A frozen cheese sandwich as defined in claim 14 wherein said cheese layer is a flat single mass.

23. A frozen cheese sandwich as defined in claim 13 wherein said cheese layer is a flat single mass.

24. A frozen cheese sandwich as defined in claim 12 wherein said cheese layer is a flat single mass.

25. A frozen cheese sandwich as defined in claim 11 wherein said cheese layer is a flat single mass.

26. A frozen cheese sandwich as defined in claim 15 wherein said layer is a plurality of generally parallel strips.

27. A frozen cheese sandwich as defined in claim 14 wherein said layer is a plurality of generally parallel strips.

28. A frozen cheese sandwich as defined in claim 13 wherein said layer is a plurality of generally parallel strips.

29. A frozen cheese sandwich as defined in claim 12 wherein said layer is a plurality of generally parallel strips.

30. A frozen cheese sandwich as defined in claim 11 wherein said layer is a plurality of generally parallel strips.

31. A frozen sandwich for commercial sales comprising a first portion of bread cut from a first slice of crusted bread, said first portion having an outer surface, a given periphery and a center area surrounded by a marginal area; a layer of masticated, plasticized cheese cut from a moving mass and deposited on said center area and spaced inwardly from said marginal area; a second portion of bread cut from a second slice of crusted bread and overlying said first portion and said layer of cheese, said second portion having an outer surface, a periphery generally matching said periphery of said first portion and a marginal area generally matching and coextensive with said marginal area of said first portion; said marginal areas being compressed together to form a seal generally matching said peripheries of said bread portions; said outer surfaces of said bread portions being heat scorched to transform a thin skin of said portions into toasted bread; and, said cheese layer being progressively deposited on said first portion.

32. A frozen sandwich as defined in claim 31 wherein said peripheries are circular.

33. A frozen sandwich as defined in claim 32 wherein said seal includes spaced crimped indentations.

34. A frozen sandwich as defined in claim 31 wherein said seal includes spaced crimped indentations.

35. A frozen sandwich as defined in claim 11 wherein said sandwich is encapsulated in a hermetically sealed package.

36. A frozen sandwich as defined in claim 15 wherein said cheese layer has a thickness in the general range of ⅛-¼ inch.

37. A frozen sandwich as defined in claim 14 wherein said cheese layer has a thickness in the general range of ⅛-¼ inch.

38. A frozen sandwich as defined in claim 13 wherein said cheese layer has a thickness in the general range of ⅛-¼ inch.

39. A frozen sandwich as defined in claim 12 wherein said cheese layer has a thickness in the general range of ⅛-¼ inch.

40. A frozen sandwich as defined in claim 11 wherein said cheese layer has a thickness in the general range of ⅛-¼ inch.

41. A frozen sandwich for commercial sales comprising a first slice of crusted bread, said first slice having an outer surface and a center area surrounded by a marginal area inward of said crust; a layer of masticated, plasticized cheese deposited on said center area and spaced inwardly from said marginal area; a second slice of crusted bread and overlying said first slice and said layer of cheese, said second portion having an outer surface, and a marginal area inward of said crust and generally matching and coextensive with said marginal area of said first slice; said marginal areas being compressed together to form a seal around said cheese layer; and, said outer surfaces of said bread portions being heat scorched to transform a thin skin of said portions into toasted bread.

42. A frozen sandwich as defined in claim 41 wherein said peripheries are circular.

43. A frozen sandwich as defined in claim 42 wherein said seal includes spaced crimped indentations.

44. A frozen sandwich as defined in claim 41 wherein said seal includes spaced crimped indentations.

45. A frozen sandwich as defined in claim 41 wherein said sandwich is encapsulated in a hermetically sealed package.

46. A method of making a crustless sandwich, said method comprising:
(a) providing a loaf of sliced bread as a indexable conveyor;
(b) removing a first slice of bread from a fixed position;
(c) indexing said loaf to locate a next slice of bread at said location awaiting removal;
(d) placing said removed first slice of bread on a platen with a center clearance;
(e) moving said platen with said first slice of bread to a deposition station;
(f) depositing a layer of masticated, plasticized cheese on the center of said first slice leaving an outer section of said slice free of cheese;
(g) placing a second slice of bread over said first slice to form a crusted sandwich;
(h) cutting said bread slices into a given shape, but encompassing said center area and said deposited cheese to form two bread portions with marginal areas surrounding said cheese;
(i) then, pressing said marginal areas of said cut bread portions together to seal said cheese between said bread portions forming a crustless sandwich; and,
(j) heating said surfaces to toast a thin layer of said surfaces.

47. A method as defined in claim 46 wherein said deposition act progressively forces said plasticized cheese onto said first slice.

48. A method as defined in claim 47 wherein said cheese layer is a flat single mass.

49. A method as defined in claim 47 wherein said cheese layer is a plurality of generally parallel strips.

50. A method as defined in claim 46 wherein said heating act includes:
(k) heating said surface of said first slice;
(l) turning said crustless sandwich over; and
(m) heating said surface of said second slice.

51. A method as defined in claim 50 including the act of freezing said sandwich.

52. A method as defined in claim 47 including the act of freezing said sandwich.

53. A method as defined in claim 46 including the act of freezing said sandwich.

54. A method of making a crustless sandwich, said method comprising:
(a) placing a first slice of bread on a first platen with a center clearance;
(b) placing a second slice of bead on a second platen with a center clearance;
(c) moving said platens along parallel paths with said first slices of bread to a deposition station;
(d) depositing a layer of masticated, plasticized cheese on the center of said first and second slices leaving an outer section of each of said slices free of cheese;
(e) placing a third slice of bread over said first slice to form a first crusted sandwich;
(f) placing a fourth slice of bread over said second slice to form a second crusted sandwich;
(g) cutting said first and third bread slices into a given shape, but encompassing said center area between said slices and said deposited cheese to form two bread portions with marginal areas surrounding said cheese;
(h) cutting said second and fourth bread slices into a given shape, but encompassing said center area between said slices and said deposited cheese to form two bread portions with marginal areas surrounding said cheese;
(i) pressing said marginal areas of said bread portions cut from said first and third slices together to seal said cheese between said bread portions forming a first crustless sandwich for said first crusted sandwich;
(j) pressing said marginal areas of said bread portions cut from said second and fourth slices together to seal said cheese between said bread portions forming a second crustless sandwich for said second crusted sandwich; and,
(k) heating said surfaces to toast a thin layer of said surfaces to form two pre-grilled sandwiches.

55. A method as defined in claim 54 wherein said deposition act progressively forces said plasticized cheese layers onto said first and third slices.

56. A method as defined in claim 55 wherein said cheese layers are flat single masses.

57. A method as defined in claim 55 wherein said cheese layers are a plurality of generally parallel strips.

58. A method as defined in claim 54 wherein said heating act includes:
(l) heating said surfaces of said first and second slices;
(m) turning said crustless sandwiches over; and
(n) heating said surface of said third and fourth slices.

59. A method as defined in claim 58 including the act of freezing said crustless sandwiches.

60. A method as defined in claim 55 including freezing said sandwich.

61. A method as defined in claim 54 including the act of freezing said sandwich.

62. A method for depositing a masticated, plasticized layer of cheese onto the bottom slice of bread in a process to make a crustless cheese sandwich, said method comprising:
(a) providing a mass of cheese;
(b) masticating and pumping said cheese to a nozzle located above said slice of bread;
(c) allowing said cheese to flow from said nozzle; and,
(d) progressively causing relative movement between said nozzle to progressively deposit said layer of cheese on said bottom slice of bread.

63. A method as defined in claim 62 wherein said relative movement is linear.

64. A method as defined in claim 62 wherein said relative movement is rotary.

65. A method as defined in claim 63 wherein said nozzle has a single flat opening.

66. A method as defined in claim 63 wherein said nozzle has a plurality of openings.

67. A method as defined in claim 62 wherein said relative movement is by moving said nozzle.

68. A method for depositing a masticated, plasticized layer of cheese with a given shape onto the bottom slice of bread in a process to make a crustless cheese sandwich, said method comprising:
(a) providing a mass of cheese;
(b) masticating and pumping said cheese to a nozzle located above said slice of bread, said nozzle having an opening having said given shape;
(c) allowing said cheese to flow a given distance from said nozzle;
(d) cutting a section of said cheese with a given thickness from said cheese flowing from said nozzle opening; and,
(e) allowing said section to drop on said bottom slice of bread.

69. An apparatus for making a crustless pre-grilled cheese sandwich, said apparatus comprising: a denester to capture an individual slice of bread from a loaf of bread, a conveyor with platens each with outer cut and seal surface and a center recess, a first depositor to deposit said individual slice of bread into one of said platens, a cheese layer depositor with a nozzle to force a layer of masticated, plasticized cheese onto the center of said individual slice of bread; a second depositor to deposit a second slice of bread over said individual slice on said platen; a cutter with a cutting edge to cut crust from said bread slices; a sealing ring to press said bread slices together in an area surrounding said cheese to form a crustless sandwich; a device to remove said sandwich from said platen; a conveyor to convey said sandwich through a heater to toast the outer surface of said second slice; a device to flip said sandwich to expose said individual slice; a heater to then toast the outer surface of said individual slice; and a freezer to freeze said sandwich.

70. An apparatus as defined in claim 69 wherein said layer depositor includes a cheese outlet nozzle above said individual slice and a device to move said nozzle above said individual slice as cheese is forced from said outlet.

71. An apparatus as defined in claim 70 wherein said device moves said nozzle in a linear direction.

72. An apparatus as defined in claim 70 wherein said device rotates said nozzle.

73. An apparatus as defined in claim 69 wherein said layer deposition includes a cheese outlet nozzle with a given shape and above said individual slice and a cutter to cut off a layer of cheese as it is forced from said outlet whereby said layer drops on said individual slice.

74. A device for depositing a masticated, plasticized layer of cheese with a given shape onto the bottom slice of bread in an apparatus to make a crustless cheese sandwich, said device comprising: a container of plasticized cheese; a pump to pump said cheese to a nozzle located above said slice of bread with the nozzle having an opening with said given shape; a cutter to cut a section of cheese with a given thickness from cheese flowing from said nozzle opening whereby said cut section of cheese is allowed to drop onto said slice of bread.

75. A method of making a crustless sandwich, said method comprising:
(a) providing a loaf of sliced bread on a indexable conveyor;
(b) removing a first slice of bread from said loaf at a fixed position;
(c) indexing said loaf to locate a next slice of bread at said position awaiting removal;
(d) placing said removed first slice of bread on a platen with a center clearance recess;
(e) moving said platen with said first slice of bread to a deposition station;
(f) depositing a filling layer on the center of said first slice leaving an outer section of said slice free of cheese;
(g) placing a second slice of bread over said first slice to form a crusted sandwich;
(h) cutting said bread slices into a given shape, but encompassing said center area and said deposited filling to form two bread portions with marginal areas surrounding said filling; and,
(i) then, pressing said marginal areas of said cut bread portions together to seal said filling between said bread portions forming a crustless sandwich.

76. A method as defined in claim 75 wherein said deposition act progressively forces said filling onto said first slice.

77. A method as defined in claim 75 including freezing said sandwich.

78. A method as defined in claim 75 including indenting said pressed marginal areas at spaced positions to increase the holding force of said seal.

79. A method as defined in claim 75 wherein said filling is two layers of peanut butter encapsulating a layer of jelly.

80. A method as defined in claim 75 wherein said filling is a layer of masticated, plasticized cheese.

81. A method of making a crustless sandwich, said method comprising:
(a) placing a first slice of bread on a first platen with a center clearance recess;
(b) placing a second slice of bead on a second platen with a center clearance recess;
(c) moving said platens along parallel paths with said first slices of bread to a deposition station;
(d) depositing a layer of a filling on the center areas of said first and second slices leaving an outer section of each of said slices free of filling;
(e) placing a third slice of bread over said first slice to form a first crusted sandwich;
(f) placing a fourth slice of bread over said second slice to form a second crusted sandwich;
(g) cutting said first and third bread slices into a given shape, but encompassing said center area between said slices and said deposited filling to form two bread portions with marginal areas surrounding said filling;
(h) cutting said second and fourth bread slices into a given shape, but encompassing said center area between said slices and said deposited filling to form two bread portions with marginal areas surrounding said filling;
(i) pressing said marginal areas of said bread portions cut from said first and third slices together to seal said filling between said bread portions forming a first crustless sandwich for said first crusted sandwich; and,
(j) pressing said marginal areas of said bread portions cut from said second and fourth slices together to seal said filling between said bread portions forming a second crustless sandwich for said second crusted sandwich.

82. A method as defined in claim 81 wherein said filling is two layers of peanut butter encapsulating a layer of jelly.

83. A method as defined in claim 81 wherein said filling is a layer of masticated, plasticized cheese.

84. A method as defined in claim 81 wherein said deposition act progressively forces said plasticized cheese layers onto said first and third slices.

85. A method as defined in claim 81 wherein said cheese layers are flat single masses.

86. A method as defined in claim 80 further comprising:
(j) providing a mass of cheese;
(k) masticating and pumping said cheese to a nozzle located above said slice of bread, said nozzle having an opening having said given shape;
(l) allowing said cheese to flow a given distance from said nozzle;
(m) cutting a section of said cheese with a given thickness from said cheese flowing from said nozzle opening; and,
(n) allowing said section to drop on said bottom slice of bread.

87. A method as defined in claim 80 further comprising:
(j) providing a mass of cheese;
(k) masticating and pumping said cheese to a nozzle located above said slice of bread, said nozzle having an opening having said given shape;
(l) allowing said cheese to flow a given distance from said nozzle;
(m) cutting a section of said cheese with a given thickness from said cheese flowing from said nozzle opening; and,
(n) allowing said section to drop on said bottom slice of bread.

88. A method of making a crustless sandwich, said method comprising:
(a) providing a first slice of a crustless bread;
(b) placing said first slice on a support structure;
(c) placing a filling layer on the center of said first slice;
(d) covering said first slice of crustless bread with a second slice of crustless bread; and,
(e) compressing said bread slices together in a continuous pattern surrounding said filling to seal said bread slices around said filling.

89. A method as defined in claim 88 wherein said filling is a layer of masticated, plasticized cheese.

90. A method as defined in claim 88 wherein said filling is a layer of jelly between two layers of peanut butter with said peanut butter layers encapsulating said jelly layer.

91. A method of depositing a layer of masticated, plasticized cheese by a movable nozzle onto a slice of bread below said nozzle and movable in a production line for making commercial cheese sandwiches, said method comprising:
(a) providing an injection chamber with an injection piston movable between a retracted position and an extended position;
(b) moving said piston to said retracted position creating a receiving volume in said chamber;
(c) pumping masticated, plasticized cheese into said chamber volume;
(d) forcing said piston toward the extended position to reduce said volume and force said cheese from said chamber and through said nozzle as it moves above said slice of bread.

92. An apparatus for depositing a layer of masticated, plasticized cheese onto a slice of brad movable in a production line for making commercial cheese sandwiches, said apparatus comprising a nozzle movable over said slice of bread, an injection chamber with an injection piston movable between a retracted position and an extended position, a pump to force cheese into said chamber when said piston is retracted, an actuator to force said piston toward said extended position and a conduit to directly force cheese from said chamber to said nozzle for deposition onto said bread slice.

93. An apparatus as defined in claim 92 wherein said nozzle has an opening with a cross-section matching a desired shape of said deposited cheese and including a cutter at said nozzle, said cutter being a slicing member movable across said opening to cut off a section of cheese forced through said opening.

94. A device for depositing pumped masticated, plasticized cheese onto a slice of bread in a production line for making commercial cheese sandwiches, said device comprising a nozzle having an opening with a cross-section matching a desired shape of deposited cheese, a pump to force masticated, plasticized cheese through said opening a cutter movable across said opening to cut a section op pumped cheese for deposition onto said bread slices.

95. A device as defined in claim 94 wherein said pump is a piston in an injection chamber filled with said cheese and connected to said nozzle.

96. A device as defined in claim 94 wherein said pump is a dual screw injector connected to said nozzle.

97. A method of making a crustless sandwich, said method comprising:
(a) providing a first crusted slice of read having a generally circular shape with a center area;
(b) depositing a layer of food on said center area leaving a surrounding marginal portion of uncovered bread;
(c) placing a second crusted slice of bread having said generally circular shape with a center area over said layer and a surrounding marginal portion overlying said marginal portion on said first slice;
(d) cutting said marginal portions of said first and second slices in a configuration encompassing said center areas; and,
(e) compressing said marginal portions together until t hey are bonded but not converted into a homogeneous, amorphous mass.

98. A method as defined in claim 97 wherein said layer of food is cheese.

99. A method as defined in claim 97 wherein said layer of food is a layer of masticated, plasticized cheese.

100. A method as defined in claim 97 wherein said layer of food is a slice of cheese.

101. A method as defined in claim 97 wherein said layer of food comprises a first layer of peanut butter, a center layer of jelly and a covering layer of peanut butter sealed to said first layer of peanut butter to encapsulate said jelly layer.

102. A method of making a crustless sandwich, said method comprising:
(a) providing a first slice of read having a generally circular shape with a center area;
(b) depositing a layer of food on said center area leaving a surrounding marginal portion of uncovered bread;
(c) placing a second slice of bread having said generally circular shape with a center area over said layer and a surrounding marginal portion overlying said marginal portion on said first slice; and,
(d) compressing said marginal portions together until they are bonded but not converted into a homogeneous, amorphous mass.

103. A method as defined in claim 102 wherein said layer of food is cheese.

104. A method as defined in claim 102 wherein said layer of food is a layer of masticated, plasticized cheese.

105. A method as defined in claim 102 wherein said layer of food is a slice of cheese.

106. A method as defined in claim 102 wherein said layer of food comprises a first layer of peanut butter, a center layer of jelly and a covering layer of peanut butter sealed to said first layer of peanut butter to encapsulate said jelly layer.

107. A method as defined in claim 106 including cutting said marginal portions of said first and second slices in a configuration encompassing said center areas before compressing said marginal portions.

108. A method as defined in claim 103 including cutting said marginal portions of said first and second slices in a configuration encompassing said center areas before compressing said marginal portions.

109. A method as defined in claim 102 including cutting said marginal portions of said first and second slices in a configuration encompassing said center areas before compressing said marginal portions.
